(19) United States
(12) Patent Application Publication
(10) Pub. No.: US 2023/0401446 A1
(43) Pub. Date: Dec. 14, 2023

(54) CONVOLUTIONAL NEURAL NETWORK PRUNING PROCESSING METHOD, DATA PROCESSING METHOD, AND DEVICE

(71) Applicant: HUAWEI TECHNOLOGIES CO., LTD., SHENZHEN (CN)

(72) Inventors: Yehui TANG, Shenzhen (CN); Yixing XU, Shenzhen (CN); Yunhe WANG, Beijing (CN); Chunjing XU, Shenzhen (CN)

(21) Appl. No.: 18/238,016

(22) Filed: Aug. 25, 2023

Related U.S. Application Data
(63) Continuation of application No. PCT/CN2022/077245, filed on Feb. 22, 2022.

(30) Foreign Application Priority Data
Feb. 27, 2021 (CN) 202110221926.3

(51) Int. Cl. G06N 3/082; G06N 3/0464

(52) U.S. Cl. CPC G06N 3/082; G06N 3/0464; G06V 10/82

(57) ABSTRACT

Embodiments of this application disclose a convolutional neural network pruning processing method, a data processing method, and a device, which may be applied to the field of artificial intelligence. The convolutional neural network pruning processing method includes: performing sparse training on a convolutional neural network by using a constructed objective loss function, where the objective loss function may include three sub-loss functions.

### CROSS-REFERENCE TO RELATED APPLICATIONS

This application is a continuation of International Application No. PCT/CN2022/077245, filed on Feb. 22, 2022, which claims priority to Chinese Patent Application No. 202110221926.3, filed on Feb. 27, 2021. The disclosures of the aforementioned applications are hereby incorporated by reference in their entireties.

### TECHNICAL FIELD

This application relates to the field of machine learning, and in particular, to a convolutional neural network pruning processing method, a data processing method, and a device.

### BACKGROUND

In recent years, convolutional neural networks are widely applied to fields such as computer vision (for example, image classification, target detection, and video analysis), machine translation, and speech recognition. However, with development of convolutional neural network technologies, a design of a network structure of the convolutional neural network becomes increasingly complex, resulting in a large model and high calculation complexity of the convolutional neural network. This restricts application of the convolutional neural network on hardware resources with limited computing capabilities and storage space, for example, a mobile device (such as a mobile phone) and a wearable device. Therefore, to apply the convolutional neural network to a small mobile device with limited computing resources, compression and acceleration need to be performed on the convolutional neural network. A common model compression method is to perform pruning processing on the convolutional neural network.

Pruning reduces a model size and model calculation complexity by reducing a quantity of convolution kernels (which may also be referred to as a quantity of channels) at a convolutional layer. In a common pruning method, importance of convolution kernels is determined by using a static channel control factor. A training process of the pruning method is mainly as follows: First, the channel control factor is set or added to a convolutional neural network, where the channel control factor is represented by using a one-dimensional vector, each element in the one-dimensional vector corresponds to one convolution kernel of the convolutional neural network, and a value of each element represents importance of a corresponding convolution kernel; and the channel control factor of the convolutional neural network is trained, an unimportant convolution kernel is deleted (that is, pruned) based on a value of the channel control factor, and the pruned convolutional neural network is iteratively trained.

The foregoing conventional pruning method is a pruning method for permanently deleting a channel. A “static” convolutional neural network can be obtained by using the method. The pruned convolutional neural network ignores different requirements of different input data for network parameters and capacities. Actually, the importance of the convolution kernel depends largely on the input data.

### SUMMARY

Embodiments of this application provide a convolutional neural network pruning processing method, a data processing method, and a device. Sparse training is performed on a convolutional neural network by constructing a new objective loss function. The newly constructed objective loss function may include two sub-loss functions. A first sub-loss function is used to measure complexity of a training sample, and a second sub-loss function is used to measure complexity of a pruned sub-network that processes the training sample. The complexity of the network is obtained based on a channel importance function and a dynamic weight. When a value of the first sub-loss function does not reach a first threshold, the complexity of the training sample is high, a value of the dynamic weight is small (inverse correlation), sparsity of the channel importance function obtained through training is small, and less pruning is performed. In this way, each training sample is flexibly pruned.

In view of this, embodiments of this application provide the following technical solutions.

According to a first aspect, an embodiment of this application first provides a convolutional neural network pruning processing method, which may be applied to the field of artificial intelligence, and may be specifically applied to fields such as computer vision (for example, image classification, target detection, and video analysis), machine translation, and speech recognition. The method includes: First, a training device may determine a first sub-loss function based on a target task. The first sub-loss function represents a difference between a training sample input to a convolutional neural network (that is, a target convolutional neural network) on which pruning processing is to be performed and an output prediction result. In this embodiment of this application, the training device may first select, from a plurality of existing types of convolutional neural networks, a convolutional neural network that is suitable for processing the target task, or may construct a network structure of a convolutional neural network that meets the target task. The selected convolutional neural network or the self-constructed convolutional neural network may be referred to as the target convolutional neural network. The target convolutional neural network is a convolutional neural network used for training, and the target convolutional neural network has different network parameters and loss functions in training processes for different training samples. In addition to determining the first sub-loss function based on the target task, the training device may further obtain a second sub-loss function based on a channel importance function and a dynamic weight. The channel importance function may be used to represent an importance degree that is of each convolution kernel (one convolution kernel may also be referred to as a channel) in the target convolutional neural network and that is on the training sample. A value of the channel importance function may be specifically represented as a one-dimensional vector. Each element in the vector corresponds to one convolution kernel in the target convolutional neural network. Specifically, the importance degree of the convolution kernel may be reflected by using the value of the channel importance function. For example, a threshold may be set in advance. When a value of an element in the channel importance function is greater than or equal to the set threshold, it is considered that a convolution kernel corresponding to the element is an important convolution kernel and should not be pruned. When a value of an element in the channel importance function is less than the set threshold, it is considered that a convolution kernel corresponding to the element is an unimportant convolution kernel and can be pruned. In addition, when a value of the first sub-loss function does not reach a first threshold, a value of the dynamic weight is obtained based on the value of the first sub-loss function, where the value of the dynamic weight is in an inverse correlation with the value of the first sub-loss function. After determining an expression of the first sub-loss function and an expression of the second sub-loss function, the training device may obtain an objective loss function based on the first sub-loss function and the second sub-loss function. After constructing the corresponding objective loss function, the training device may perform sparse training on the target convolutional neural network by using the objective loss function to obtain a trained target convolutional neural network. The sparsening is pruning a convolution kernel of the target convolutional neural network based on the value of the channel importance function, and is specifically pruning a convolution kernel whose value of an importance degree is less than a second threshold.

In the foregoing embodiment, sparse training is performed on the convolutional neural network by constructing the new objective loss function. The newly constructed objective loss function may include two sub-loss functions. The first sub-loss function is used to measure complexity of the training sample, and the second sub-loss function is used to measure complexity of a pruned sub-network that processes the training sample. The complexity of the network is obtained based on the channel importance function and the dynamic weight. When the value of the first sub-loss function does not reach the first threshold, the complexity of the training sample is high, the value of the dynamic weight is small (inverse correlation), sparsity of the channel importance function obtained through training is small, and less pruning is performed. In this way, each training sample is flexibly pruned, and redundancy of the target convolutional neural network can be fully mined.

In an embodiment, a specific implementation in which the training device obtains the objective loss function based on the first sub-loss function and the second sub-loss function may be: adding the first sub-loss function and the second sub-loss function to obtain the objective loss function.

In the foregoing embodiment, an implementation of how to obtain the objective loss function based on the first sub-loss function and the second sub-loss function is specifically described, and is simple and easy to implement.

In an embodiment, in addition to that the sample is mapped to complexity space, a similarity between training samples may also help customize proper sub-network structures for different training samples. In other words, it is expected that similar training samples may be input to similar sub-networks. Therefore, in addition to determining the first sub-loss function based on the target task and obtaining the second sub-loss function based on the channel importance function and the dynamic weight, the training device may further obtain a third sub-loss function based on a first similarity and a second similarity. The first similarity represents a similarity between a feature map extracted from a first training sample and a feature map extracted from a second training sample, and the second similarity represents a similarity between a first channel importance parameter and a second channel importance parameter. The first channel importance parameter is a value that is obtained by inputting the first training sample and that is of the channel importance function, and the second channel importance parameter is a value that is obtained by inputting the second training sample and that is of the channel importance function. The first training sample and the second training sample are separately any two different samples in a training set. After determining the expression of the first sub-loss function, the expression of the second sub-loss function, and an expression of the third sub-loss function, the training device may obtain the objective loss function based on the first sub-loss function, the second sub-loss function, and the third sub-loss function.

In the foregoing embodiment, in addition to the complexity of the sample, both the complexity of the sample and a similarity between samples are further considered. In other words, it is not only expected that a training sample with high complexity is input to a sub-network with a large capacity for prediction, but also expected that similar training samples can be input to similar sub-networks (that is, similar pruning is performed) for prediction, so that the redundancy in the target convolutional neural network can be more fully mined.

In an embodiment, a specific implementation of obtaining the third sub-loss function based on the first similarity and the second similarity may be: after the first similarity and the second similarity are separately converted into one-dimensional vectors (for example, a pooling operation), using a distance function between the first similarity and the second similarity as the third sub-loss function.

In the foregoing embodiment, an expression form of the third sub-loss function is specifically described, and is easy to operate.

In an embodiment, the first similarity specifically represents a cosine similarity between the feature map extracted from the first training sample and the feature map extracted from the second training sample; and the second similarity specifically represents a cosine similarity between the first channel importance parameter and the second channel importance parameter.

In the foregoing embodiment, a specific manner of measuring the first similarity and the second similarity is specifically described, and feasibility is achieved.

In an embodiment, a specific implementation in which the training device obtains the objective loss function based on the first sub-loss function, the second sub-loss function, and the third sub-loss function may be: adding the first sub-loss function, the second sub-loss function, and a first product result to obtain the objective loss function, where the first product result is a result obtained by multiplying the third sub-loss function by a preset coefficient (which may be referred to as a first preset coefficient).

In the foregoing embodiment, an implementation of how to obtain the objective loss function based on the first sub-loss function, the second sub-loss function, and the third sub-loss function is specifically described, and is simple and easy to implement.

In an embodiment, that a value of the dynamic weight is obtained based on the value of the first sub-loss function may be specifically: obtaining the value of the dynamic weight by multiplying a first ratio by a second preset coefficient, where the first ratio is a ratio of a first difference to the first threshold, and the first difference is a difference between the first threshold and the value of the first sub-loss function.

In the foregoing embodiment, a specific expression form of the dynamic weight is described, and the dynamic weight is related to the value of the first sub-loss function, so that a dynamic pruning process can be implemented.

In an embodiment, a specific implementation of obtaining the second sub-loss function based on the channel importance function and the dynamic weight may be: multiplying the channel importance function by the dynamic weight to obtain the second sub-loss function.

In the foregoing embodiment, a specific expression form of the second sub-loss function is specifically described, and is simple and easy to implement.

In an embodiment, when the value of the first sub-loss function reaches the first threshold, it is considered that a corresponding training sample is a complex sample. In this case, the value of the dynamic weight is 0.

In the foregoing embodiment, another case of the value of the dynamic weight is specifically described, and wide coverage is achieved.

In an embodiment, when the target task is a classification task, the first sub-loss function may be a cross-entropy loss function. When the target task is another specific task (for example, a regression task), the first sub-loss function may be a common loss function such as a perceptual loss function or a hinge loss function. Selection of the first sub-loss function is specifically related to a type of the target task, and a specific representation form of the first sub-loss function is determined by the type of the target task. This is not specifically limited in this embodiment of this application.

In the foregoing embodiment, a determining principle of the first sub-loss function is described, and operability is achieved.

In an embodiment, the target convolutional neural network obtained through sparse training may be deployed on a target device, for example, may be deployed on an edge device with a limited computing capability, such as a mobile phone or an intelligent wearable device (for example, a smart band or a smart watch).

In the foregoing embodiment, a deployment scenario of the trained target convolutional neural network is described, so that the edge device with limited computing capability can also accelerate an inference process, thereby improving user experience.

According to a second aspect, an embodiment of this application further provides a data processing method. The method includes: First, an execution device obtains to-be-processed input data, where the input data is related to a to-be-processed target task. For example, when the target task is a classification task, the input data is data used for classification. Then, the execution device prunes a trained target convolutional neural network based on the input data to obtain a pruned sub-network, where the trained target convolutional neural network is obtained through training based on a newly constructed objective loss function. For example, the objective loss function may be specifically obtained based on a first sub-loss function and a second sub-loss function. The first sub-loss function is determined based on the target task, and the second sub-loss function is determined based on a channel importance function and a dynamic weight. The first sub-loss function represents a difference between a training sample input to the target convolutional neural network and an output prediction result. When a value of the first sub-loss function does not reach a first threshold, a value of the dynamic weight is obtained based on the value of the first sub-loss function. The value of the dynamic weight is in an inverse correlation with the value of the first sub-loss function, the objective loss function is used to perform sparsening on the target convolutional neural network during training of the target convolutional neural network, and the sparsening is pruning a convolution kernel of the target convolutional neural network based on a value of the channel importance function.

It should be noted that in this embodiment of this application, types of the input data vary based on different target tasks. Several typical application scenarios of the target tasks are described herein.

(1) The target task is a target detection task.

The target detection task is usually for detecting a target object in an image. In this case, the input data is usually an input image. The execution device prunes the trained target convolutional neural network based on the input image to obtain a pruned sub-network, and performs target detection on the input image by using the sub-network to obtain a detection result, that is, output data is the detection result.

(2) The target task is the classification task.

In an embodiment, the classification task may be performed on an image. In this case, the input data is an input image. The execution device needs to prune the trained target convolutional neural network based on the input image to obtain a pruned sub-network, classifies the input image by using the sub-network, and outputs a classification result, that is, output data is the classification result of the image.

In another embodiment, the classification task may be performed on an image, or may be performed on a text or audio. In this case, the input data is corresponding text data or audio data. The execution device prunes, based on the input text or audio, the trained target convolutional neural network to obtain a pruned sub-network, classifies the input text or audio by using the sub-network, and outputs a classification result, that is, output data is a text classification result or an audio classification result.

The foregoing describes only target tasks in several scenarios. In different target tasks, the input data and the output data are related to the target task, and specific examples are not provided herein.

In the foregoing embodiment, how to perform a corresponding task on the input data by using the trained target convolutional neural network is specifically described. The trained target convolutional neural network is obtained through training by using the foregoing constructed objective loss function. The trained target convolutional neural network may perform dynamic pruning processing for different input data to obtain a pruned sub-network corresponding to the input data, thereby accelerating an inference process.

In an embodiment, a specific implementation of pruning, by the execution device, the trained target convolutional neural network based on the input data to obtain the pruned sub-network may alternatively be: pruning the trained target convolutional neural network based on the input data and a pruning rate to obtain the pruned sub-network, where the pruning rate is a proportion of the pruned convolution kernel to all convolution kernels in the target neural network.

In the foregoing embodiment, that pruning processing may be further implemented on the trained target neural network based on both the input data and the pruning rate to further accelerate the inference process is described.

In an embodiment, that a value of the dynamic weight is obtained based on the value of the first sub-loss function may be specifically: obtaining the value of the dynamic weight by multiplying a first ratio by a second preset coefficient, where the first ratio is a ratio of a first difference to the first threshold, and the first difference is a difference between the first threshold and the value of the first sub-loss function.

In the foregoing embodiment, a specific expression form of the dynamic weight is described, and the dynamic weight is related to the value of the first sub-loss function, so that a dynamic pruning process can be implemented.

In an embodiment, when the value of the first sub-loss function reaches the first threshold, it is considered that corresponding input data is a complex sample. In this case, the value of the dynamic weight is 0.

In the foregoing embodiment, another case of the value of the dynamic weight is specifically described, and wide coverage is achieved.

In an embodiment, the input data may be image data, audio data, or text data, and a data type of the input data is determined by the to-be-processed target task. This is not specifically limited herein.

In the foregoing embodiment, several types of input data are specifically described, and flexibility is achieved.

According to a third aspect, an embodiment of this application provides a training device, and the training device has a function of implementing the method in any one of the first aspect or the possible implementations of the first aspect. The function may be implemented by hardware, or may be implemented by hardware executing corresponding software. The hardware or the software includes one or more modules corresponding to the function.

According to a fourth aspect, an embodiment of this application provides an execution device, and the execution device has a function of implementing the method according to any one of the second aspect or the possible implementations of the second aspect. The function may be implemented by hardware, or may be implemented by hardware executing corresponding software. The hardware or the software includes one or more modules corresponding to the function.

According to a fifth aspect, an embodiment of this application provides a training device. The training device may include a memory, a processor, and a bus system. The memory is configured to store a program. The processor is configured to invoke the program stored in the memory to perform the method according to any one of the first aspect or the possible implementations of the first aspect in embodiments of this application.

According to a sixth aspect, an embodiment of this application provides an execution device. The execution device may include a memory, a processor, and a bus system. The memory is configured to store a program. The processor is configured to invoke the program stored in the memory to perform the method according to any one of the second aspect or the possible implementations of the second aspect in embodiments of this application.

According to a seventh aspect, an embodiment of this application provides a computer-readable storage medium. The computer-readable storage medium stores instructions. When the instructions are run on a computer, the computer is enabled to perform the method according to any one of the first aspect or the possible implementations of the first aspect, or the computer is enabled to perform the method according to any one of the second aspect or the possible implementations of the second aspect.

According to an eighth aspect, an embodiment of this application provides a computer program. When the computer program runs on a computer, the computer is enabled to perform the method according to any one of the first aspect or the possible implementations of the first aspect, or the computer is enabled to perform the method according to any one of the second aspect or the possible implementations of the second aspect.

According to a ninth aspect, an embodiment of this application provides a chip. The chip includes at least one processor and at least one interface circuit, where the interface circuit is coupled to the processor. The at least one interface circuit is configured to: perform sending and receiving functions, and send instructions to the at least one processor. The at least one processor is configured to run a computer program or the instructions. The at least one processor has a function of implementing the method according to any one of the first aspect or the possible implementations of the first aspect, or the at least one processor has a function of implementing the method according to any one of the second aspect or the possible implementations of the second aspect. The function may be implemented by hardware, may be implemented by software, or may be implemented by using a combination of hardware and software. The hardware or software includes one or more modules corresponding to the foregoing function. In addition, the interface circuit is configured to communicate with another module other than the chip. For example, the interface circuit may send a trained target convolutional neural network obtained by the processor on the chip to various edge devices (for example, a mobile phone, a personal computer, or a smart watch) to execute a corresponding target task.

### BRIEF DESCRIPTION OF DRAWINGS

FIG. 1 is a schematic diagram of a structure of an artificial intelligence main framework according to an embodiment of this application;

FIG. 2 is a diagram of a system architecture of a task processing system according to an embodiment of this application;

FIG. 3 is a schematic flowchart of a convolutional neural network pruning processing method according to an embodiment of this application;

FIG. 4 is a schematic diagram of dynamically balancing complexity of a sample and complexity of a network in a convolutional neural network pruning processing method according to an embodiment of this application;

FIG. 5 is a scenario application diagram according to an embodiment of this application;

FIG. 6 is another schematic flowchart of a convolutional neural network pruning processing method according to an embodiment of this application;

FIG. 7 is a schematic diagram of customizing a corresponding sub-network structure for each training sample by using manifold information of a training sample according to an embodiment of this application;

FIG. 8 is a schematic flowchart of a data processing method according to an embodiment of this application;

FIG. 9 is a diagram of comparison between results, obtained through classification by using a pruning method according to an embodiment of this application, of a ResNet network on an ImageNet dataset, and results, obtained through classification by using an existing pruning method, of the ResNet network on the ImageNet dataset;

FIG. 10 is a diagram of comparison between results, obtained through classification by using a pruning method according to an embodiment of this application, of a MobileNetV2 network on an ImageNet dataset, and results, obtained through classification by using an existing pruning method, of the MobileNetV2 network on the ImageNet dataset;

FIG. 11 is a diagram of comparison between results of a pruning method according to an embodiment of this application on a CIFAR-10 dataset and results of an existing pruning method on the CIFAR-10 dataset;

FIG. 12 is a schematic diagram of a training device according to an embodiment of this application;

FIG. 13 is a schematic diagram of an execution device according to an embodiment of this application;

FIG. 14 is another schematic diagram of a training device according to an embodiment of this application;

FIG. 15 is another schematic diagram of an execution device according to an embodiment of this application; and

FIG. 16 is a schematic diagram of a structure of a chip according to an embodiment of this application.

### DESCRIPTION OF EMBODIMENTS

Embodiments of this application provide a convolutional neural network pruning processing method, a data processing method, and a device. Sparse training is performed on a convolutional neural network by constructing a new objective loss function. The newly constructed objective loss function may include two sub-loss functions. A first sub-loss function is used to measure complexity of a training sample, and a second sub-loss function is used to measure complexity of a pruned sub-network that processes the training sample. The complexity of the network is obtained based on a channel importance function and a dynamic weight. When a value of the first sub-loss function does not reach a first threshold, the complexity of the training sample is high, a value of the dynamic weight is small (inverse correlation), sparsity of the channel importance function obtained through training is small, and less pruning is performed. In this way, each training sample is flexibly pruned.

In the specification, claims, and the accompanying drawings of this application, the terms “first”, “second”, and the like are intended to distinguish between similar objects but do not necessarily indicate a specific order or sequence. It should be understood that the terms used in such a way are interchangeable in proper circumstances, and this is merely a distinguishing manner used when objects that have a same attribute are described in embodiments of this application. In addition, terms “include”, “have”, and any other variations thereof are intended to cover a non-exclusive inclusion, so that a process, method, system, product, or device that includes a series of units is not limited to those units, but may include other units not expressly listed or inherent to such a process, method, product, or device.

Embodiments of this application relate to a large amount of neural network related knowledge. To better understand the solutions in embodiments of this application, the following first describes related terms and concepts that may be used in embodiments of this application. It should be understood that explanations of related concepts may be limited due to specific situations of the embodiments of this application, but it does not mean that this application can only be limited to the specific situations. There may be differences in the specific situations of different embodiments. Details are not limited herein.

(1) Neural Network

The neural network may include a neuron, and may be understood as a neural network including an input layer, a hidden layer, and an output layer. Usually, a first layer is the input layer, a last layer is the output layer, and a middle layer is the hidden layer. A neural network including a plurality of hidden layers is referred to as a deep neural network (DNN). Work of each layer in the neural network may be described by using a mathematical expression [symbol] =a(W· [symbol] +b). From a physical perspective, the work of each layer in the neural network may be understood as completing transformation from input space to output space (that is, from row space to column space of a matrix) by performing five operations on the input space (a set of input vectors). The five operations include: 1. dimension increasement/dimension reduction; 2. increasing/decreasing; 3. rotation; 4. translation; and 5. “bending”. The operations 1, 2, and 3 are completed by “W· [symbol] ”, the operation 4 is completed by “+b”, and the operation 5 is implemented by “a( )”. The word “space” is used herein for expression because a classified object is not a single thing, but a type of things. Space is a collection of all individuals of such type of things. W is a weight matrix, and each value in the matrix indicates a weight value of one neuron in the neural network at this layer. The matrix W determines space transformation from the input space to the output space described above. In other words, W at each layer of the neural network controls how to transform space. An objective of training a neural network is to finally obtain weight matrices of all layers of a trained neural network. Therefore, a training process for the neural network is essentially a manner of learning control of space transformation, and more specifically, learning a weight matrix.

(2) Convolutional Neural Network (CNN)

The CNN is a deep neural network with a convolutional structure. The convolutional neural network includes a feature extractor including a convolutional layer and a sub-sampling layer. The feature extractor may be considered as a filter. A convolution process may be considered as performing convolution by using a trainable filter and an input image or a convolution feature map. The convolutional layer is a neuron layer that is in the convolutional neural network and at which convolution processing is performed on an input signal. At the convolutional layer of the convolutional neural network, one neuron may be connected to only a part of neurons at a neighboring layer. A convolutional layer usually includes several feature planes, and each feature plane may include some neurons arranged in a rectangle. Neurons of a same feature plane share a weight, and the shared weight herein is a convolution kernel. Weight sharing may be understood as that an image information extraction manner is irrelevant to a location. A principle implied herein is that statistical information of a part of an image is the same as that of another part. This means that image information learned in a part can also be used in another part. Therefore, image information obtained through same learning can be used for all locations in the image. At a same convolutional layer, a plurality of convolution kernels may be used to extract different image information. Usually, a larger quantity of convolution kernels indicates richer image information reflected by a convolution operation.

The convolution kernel may be initialized in a form of a random-size matrix. In a process of training the convolutional neural network, the convolution kernel may obtain an appropriate weight through learning. In addition, a direct benefit brought by weight sharing is that connections between layers in the convolutional neural network are reduced and an overfitting risk is lowered.

(3) Loss Function

During training of the neural network, because it is expected that an output of the neural network is as close as possible to a value that is actually expected to be predicted, a current prediction value of the network may be compared with a target value that is actually expected, and then a matrix vector at each layer of the neural network is updated based on a difference between the current prediction value and the target value (there is usually an initialization process before the first update, that is, a parameter is preconfigured for each layer of the neural network). For example, if the prediction value of the network is large, the matrix vector is adjusted to lower the prediction value until the neural network can predict the target value that is actually expected. Therefore, “how to obtain, through comparison, a difference between the predicted value and the target value” needs to be predefined. This is a loss function or an objective function. The loss function and the objective function are important equations for measuring the difference between the predicted value and the target value. The loss function is used as an example. A higher output value (loss) of the loss function indicates a larger difference. Therefore, training of the neural network is a process of minimizing the loss as much as possible.

(4) Back Propagation Algorithm

During training of the neural network, an error back propagation (BP) algorithm may be used to correct a value of a parameter in an initial neural network model, so that a reconstruction error loss of the neural network model becomes smaller. Specifically, an input signal is transferred forward until an error loss occurs at an output, and the parameter in the initial neural network model is updated based on back propagation error loss information, to make the error loss converge. The back propagation algorithm is an error-loss-centered back propagation motion intended to obtain a parameter, such as a weight matrix, of an optimal neural network model.

(5) Regularization

The regularization is a type of method that reduces overfitting by restricting complexity of a network model.

(6) Manifold

The manifold is topological space that can be spatialized locally by Euclidean. It is a generalization of concepts of curves and surfaces in Euclidean space. Specifically, the manifold means that data that can be observed is actually mapped from a low-dimensional manifold to high-dimensional space. Due to limitation of internal data features, some high-dimensional data may generate dimension redundancy. Actually, the data can be uniquely represented in a low dimension. Intuitively, the manifold is like dd-dimensional space, which is a result obtained by distorting mm-dimensional space, where (m>d) (m>d). It should be noted that the manifold is not a shape, but space. For example, a piece of cloth may be seen as a two-dimensional plane, and this is two-dimensional space. Now the piece of cloth is twisted (three-dimensional space), and the piece of cloth becomes a manifold. Certainly, the piece of cloth is also a manifold without being twisted. The Euclidean space is a special case for manifolds. In this embodiment of this application, manifold information (that is, complexity of a sample and a similarity between samples) of sample space may be used to explore a relationship between the samples.

The following describes embodiments of this application with reference to the accompanying drawings. A person of ordinary skill in the art may learn that, with development of technologies and emergence of a new scenario, the technical solutions according to embodiments of this application are also applicable to a similar technical problem.

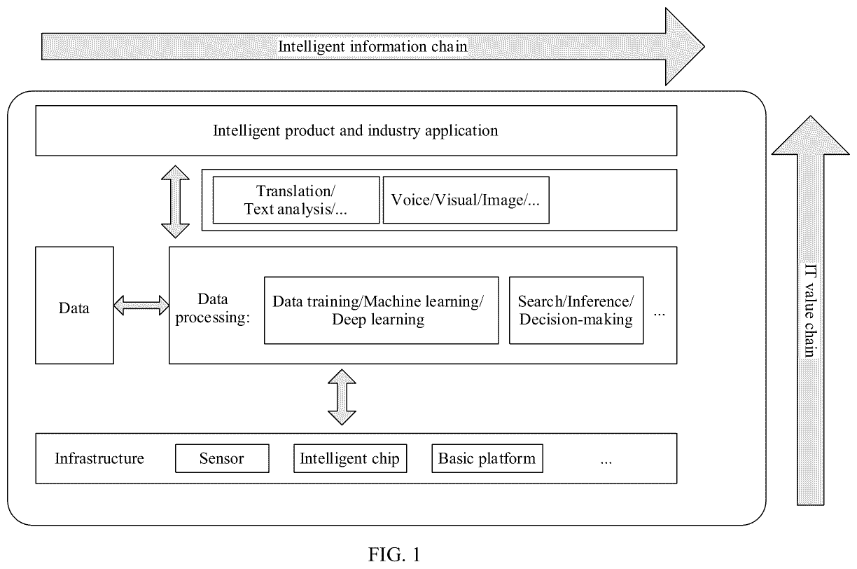

An overall working procedure of an artificial intelligence system is first described. FIG. 1 is a schematic diagram of a structure of an artificial intelligence main framework. The following describes the artificial intelligence main framework from two dimensions: an “intelligent information chain” (a horizontal axis) and an “IT value chain” (a vertical axis). The “intelligent information chain” reflects a series of processes from obtaining data to processing the data. For example, the process may be a general process of intelligent information perception, intelligent information representation and formation, intelligent inference, intelligent decision-making, and intelligent execution and output. In this process, data undergoes a condensation process of “data-information-knowledge-wisdom”. The “IT value chain” reflects a value brought by artificial intelligence to the information technology industry in a process from an underlying infrastructure and information (providing and processing technology implementation) of human intelligence to a systemic industrial ecology.

(1) Infrastructure

The infrastructure provides computing capability support for the artificial intelligence system, implements communication with the external world, and implements support by using a basic platform. External communication is performed by using a sensor. A computing capability is provided by an intelligent chip (a hardware acceleration chip, for example, a CPU, an NPU, a GPU, an ASIC, or an FPGA). The basic platform includes related platform assurance and support such as a distributed computing framework and a network, and may include cloud storage and computing, an interconnection and interworking network, and the like. For example, the sensor communicates with the outside to obtain data, and the data is provided to an intelligent chip in a distributed computing system for computation, where the distributed computing system is provided by the basic platform.

(2) Data

Data at an upper layer of the infrastructure indicates a data source in the field of artificial intelligence. The data relates to a graph, an image, a voice, and text, further relates to Internet of things data of a conventional device, and includes service data of an existing system and perception data such as force, displacement, a liquid level, a temperature, and humidity.

(3) Data Processing

Data processing usually includes manners such as data training, machine learning, deep learning, searching, inference, and decision-making.

Machine learning and deep learning may mean performing symbolized and formalized intelligent information modeling, extraction, preprocessing, training, and the like on data.

Inference is a process in which a pattern of human intelligent inference is simulated in a computer or an intelligent system, and machine thinking and problem resolving are performed by using formalized information according to an inferring control policy. A typical function is searching and matching.

Decision-making is a process in which a decision is made after intelligent information is inferred, and usually provides functions such as classification, ranking, and prediction.

(4) General Capabilities

After data processing mentioned above is performed on data, some general capabilities may further be formed based on a data processing result, for example, an algorithm or a general system, such as translation, text analysis, computer vision processing, speech recognition, and image recognition.

(5) Intelligent Product and Industry Application

Intelligent products and industry applications are products and applications of the artificial intelligence system in various fields, and are encapsulation for an overall solution of artificial intelligence, to productize intelligent information decision-making and implement applications. Application fields thereof mainly include an intelligent terminal, intelligent manufacturing, intelligent transportation, intelligent home, intelligent healthcare, intelligent security protection, autonomous driving, a safe city, and the like.

Embodiments of this application may be applied to an optimized design of a convolutional neural network, and specifically, may be applied to an optimized design of a loss function of the convolutional neural network. The convolutional neural network whose loss function is optimized in this application may be specifically applied to subdivision fields of the field of artificial intelligence, for example, the image processing field and the semantic analysis field in the computer vision field. Specifically, with reference to FIG. 1, in this embodiment of this application, data in a dataset obtained by the infrastructure may be a plurality of different types of data (which may also be referred to as training samples or training data, where a plurality of training samples form the training set) obtained by using sensors such as a camera and a radar. The training sample in the training set may be a plurality of pieces of image data, may be a plurality of pieces of video data, or may be text data, audio data, or the like, provided that the training set meets a function used to perform iterative training on the convolutional neural network. Specifically, a data type in the training set is not limited in this embodiment of this application.

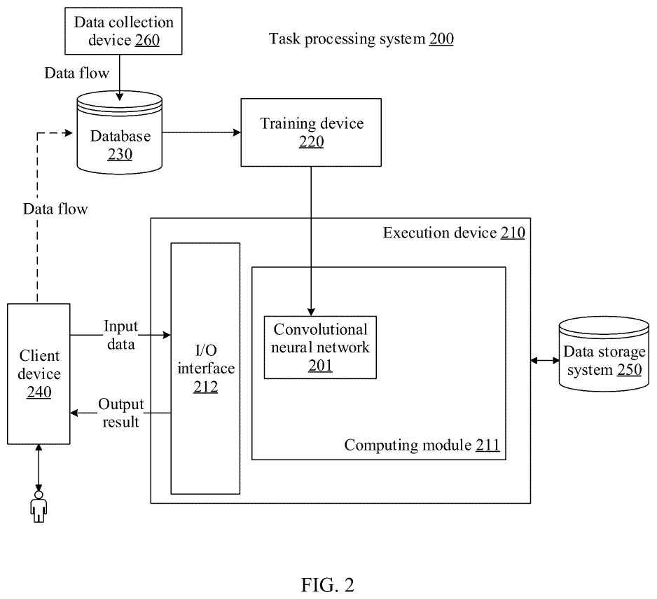

For ease of understanding of this solution, the following describes a framework of a task processing system provided in an embodiment of this application with reference to FIG. 2. FIG. 2 is a diagram of a system architecture of a task processing system according to an embodiment of this application. In FIG. 2, the task processing system 200 includes an execution device 210, a training device 220, a database 230, a client device 240, a data storage system 250, and a data collection device 260. The execution device 210 includes a computing module 211 and an input/output (I/O) interface 212.

In a training phase, the data collection device 260 may be configured to: obtain an open-source large-scale dataset (that is, a training set) required by a user, and store the training set into the database 230. The training set may include a plurality of pieces of training data (or referred to as training samples). The training data may be image data, may be video data, or may be audio data, text data, or the like; and is specifically related to a to-be-processed target task. This is not limited herein. The training device 220 performs sparse training on a convolutional neural network 201 in this application based on the maintained training set in the database 230 (that is, performs pruning processing on the convolutional neural network). The convolutional neural network 201 that is obtained through training and that can implement dynamic pruning based on each piece of training data (which may also be referred to as the training sample) may be applied to different systems or devices (that is, the execution device 210), which may be specifically edge devices or terminal-side devices, for example, mobile phones, tablet computers, laptops, monitoring systems (for example, cameras), or security systems.

In an inference phase, the execution device 210 may invoke data, code, and the like in the data storage system 250, or may store data, instructions, and the like in the data storage system 250. The data storage system 250 may be disposed in the execution device 210, or the data storage system 250 may be an external memory relative to the execution device 210. The computing module 211 implements dynamic pruning for each piece of different input data by using the convolutional neural network 201 obtained through sparse training.

In FIG. 2, the I/O interface 212 is configured for the execution device 210, to exchange data with an external device. A “user” may input data to the I/O interface 212 by using the client device 240. For example, the client device 240 may be a camera device of a monitoring system. An image photographed by the camera device is input to the computing module 211 of the execution device 210 as input data. The computing module 211 detects the input image to obtain a detection result (or a prediction result). Then, the detection result (or the prediction result) is output to the camera device, or is directly displayed on a display interface (if the execution device 210 has the display interface) of the execution device 210. In addition, in some implementations of this application, the client device 240 may alternatively be integrated into the execution device 210. For example, when the execution device 210 is a mobile phone, a target task may be directly obtained by using the mobile phone (for example, an image may be photographed by a camera of the mobile phone, or target voice may be recorded by a recording module of the mobile phone; and the target task is not limited herein), or may be received from another device (for example, another mobile phone). Then, the computing module 211 in the mobile phone detects (or predicts) the target task to obtain a detection result (or a prediction result), and the detection result (or the prediction result) is directly presented on a display interface of the mobile phone. Product forms of the execution device 210 and the client device 240 are not limited herein.

It should be noted that FIG. 2 is merely the schematic diagram of the system architecture according to this embodiment of this application, and location relationships between devices, components, modules, and the like shown in the figure do not constitute any limitation. For example, in FIG. 2, the data storage system 250 is an external memory relative to the execution device 210. In another case, the data storage system 250 may alternatively be disposed in the execution device 210. In FIG. 2, the client device 240 is a peripheral device relative to the execution device 210. In another case, the client device 240 may alternatively be integrated into the execution device 210.

In some embodiments of this application, for example, in FIG. 2, the training device 220 and the execution device 210 are independently distributed devices. However, FIG. 2 is merely the schematic diagram of the architecture of the task processing system according to this embodiment of the present invention, and location relationships between devices, components, modules, and the like shown in the figure do not constitute any limitation. In some other embodiments of this application, the training device 220 and the execution device 210 may be integrated into a same device. Further, the example in FIG. 2 is not intended to limit a quantity of devices of each type. For example, the database 230 may communicate with a plurality of client devices 240.

It should be further noted that the sparse training of the convolutional neural network 201 in this embodiment of this application may be implemented on a cloud side. For example, the training device 220 on the cloud side (the training device 220 may be disposed on one or more servers or virtual machines) may obtain a training set, and perform sparse training on the convolutional neural network based on a plurality of groups of training data (or referred to as training samples) in the training set to obtain the trained convolutional neural network 201. Then, the trained convolutional neural network 201 is sent to the execution device 210 for application. For example, if the target task is a task related to image data, for example, an image enhancement task, the trained convolutional neural network 201 may be sent to the execution device 210 to perform image enhancement processing such as image super-resolution reconstruction, deblurring, and rain removal. If the target task is a task related to audio data, text data, or the like, the trained convolutional neural network 201 may be sent to the execution device 210 to process the related task. For example, in the system architecture corresponding to FIG. 2, the training device 220 performs sparse training on the convolutional neural network, and then sends the trained convolutional neural network 201 to the execution device 210 for use. The training of the convolutional neural network 201 in the foregoing embodiment may also be implemented on a terminal side, that is, the training device 220 may be located on the terminal side. For example, a terminal device (such as a mobile phone or a smart watch) or a wheeled mobile device (such as a self-driving vehicle or an assisted driving vehicle) obtains a training set, and performs sparse training on the convolutional neural network based on a plurality of groups of training data in the training set to obtain the trained convolutional neural network 201. The trained convolutional neural network 201 may be directly used by the terminal device, or may be sent by the terminal device to another device for use. Specifically, this embodiment of this application imposes no limitation on a device (on the cloud side or the terminal side) on which sparse training is performed on the convolutional neural network 201.

With reference to the foregoing description, embodiments of this application provide a convolutional neural network pruning processing method and a data processing method, which are respectively applied to a training phase and an inference phase of a convolutional neural network. The following separately provides description.

1. Training Phase

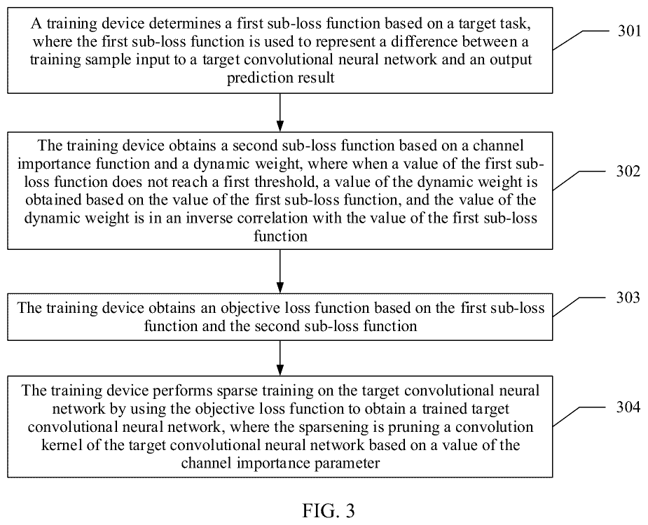

In this embodiment of this application, the training phase is a process in which the training device 220 in FIG. 2 performs a training operation on the convolutional neural network 201 by using the training data in the training set, that is, a process of performing pruning processing on the convolutional neural network by using the loss function constructed in this application. FIG. 3 is a schematic flowchart of a convolutional neural network pruning processing method according to an embodiment of this application. The method may specifically include the following operations.

Operation 301: A training device determines a first sub-loss function based on a target task, where the first sub-loss function represents a difference between a training sample input to a target convolutional neural network and an output prediction result.

First, the training device may first select, from a plurality of existing types of convolutional neural networks, a convolutional neural network that is suitable for processing the target task, or may construct a network structure of a convolutional neural network that meets the target task. The selected convolutional neural network or the self-constructed convolutional neural network may be referred to as the target convolutional neural network. It should be noted that, in some implementations of this application, if the target convolutional neural network is selected from the existing convolutional neural networks, a network parameter of the target convolutional neural network may be obtained through random initialization. Alternatively, the target convolutional neural network may be a pre-trained convolutional neural network. In a pre-training process, the target convolutional neural network may be trained in advance on a cloud side, so that a good initialized parameter can be obtained. Specifically, whether the target convolutional neural network is trained in advance is not limited in this embodiment of this application.

A purpose of inputting the training sample to the target convolutional neural network is to make correct prediction, and corresponding sub-loss functions (that is, the first sub-loss function) may be determined based on different target tasks. Therefore, the training device may determine the first sub-loss function based on the target task, where the first sub-loss function represents a difference between a training sample input to a convolutional neural network (that is, the target convolutional neural network) on which pruning processing is to be performed and an output prediction result. For example, when the target task is a classification task, the first sub-loss function may be a cross-entropy loss function. When the target task is another specific task (for example, a regression task), the first sub-loss function may be a common loss function such as a perceptual loss function or a hinge loss function. Selection of the first sub-loss function is specifically related to a type of the target task, and a specific representation form of the first sub-loss function is determined by the type of the target task. This is not specifically limited in this embodiment of this application.

In this embodiment of this application, a large value of the first sub-loss function indicates poor fitting effect of the target convolutional neural network on the currently input training sample. Therefore, the first sub-loss function substantially measures complexity of the currently input training sample.

It should be noted that, in this embodiment of this application, for ease of understanding, the first sub-loss function may be represented by [symbol] _{ce}(xᵢ, θ), where xᵢ represents an input i^{th} training sample, θ is the network parameter of the entire target convolutional neural network, and [symbol] _{ce}(·) is an expression of the first sub-loss function.

Operation 302: The training device obtains a second sub-loss function based on a channel importance function and a dynamic weight, where when a value of the first sub-loss function does not reach a first threshold, a value of the dynamic weight is obtained based on the value of the first sub-loss function, and the value of the dynamic weight is in an inverse correlation with the value of the first sub-loss function.

In addition to determining the first sub-loss function based on the target task, the training device may further obtain the second sub-loss function based on the channel importance function and the dynamic weight. The channel importance function may be used to represent an importance degree that is of each convolution kernel (one convolution kernel may also be referred to as a channel) in the target convolutional neural network and that is on the training sample. The channel importance function may be represented by π^{l}(xᵢ), and l represents any layer of the target convolutional neural network, that is l∈[1, L], where L is a total quantity of layers of the target convolutional neural network. π^{l}(xᵢ) indicates, for an input training sample xᵢ, an importance degree that is of a convolution kernel at an l^{th} layer of the target convolutional neural network and that is on the training sample xᵢ, where the channel importance function π^{l}(xᵢ) may be represented by using a vector. Then, the training device may perform dynamic pruning based on an importance degree that is of each convolution kernel and that is on any training sample. For example, a threshold (which may be referred to as a second threshold) may be set. When a value of the importance degree is less than the set second threshold (for example, the second threshold may be set to 0), it is considered that the convolution kernel corresponding to the value of the importance degree is not important for the current training sample xᵢ, and may be pruned. For each training sample, a value of the channel importance function π^{l}(xᵢ) may be different, and therefore, sparsity of the channel importance function π^{l}(xᵢ) (for example, when the second threshold is 0, more elements 0 in the vector representing the channel importance function π^{l}(xᵢ) indicate that more elements 0 need to be pruned, and an obtained sub-network is sparser) determines a quantity of convolution kernels that process the current training sample xᵢ and that are in the target convolutional neural network. A large value of the channel importance function π^{l}(xᵢ) corresponds to a compact sub-network (indicating that less pruning is performed).

Therefore, in this embodiment of this application, essentially, complexity of the target convolutional neural network for each training sample is measured based on the channel importance function π^{l}(xᵢ). Specifically, that the channel importance function π^{l}(xᵢ) is sparser indicates more pruning needs to be performed, and a sub-network obtained by pruning the target convolutional neural network is simpler. That the channel importance function π^{l}(xᵢ) is denser indicates that less pruning needs to be performed, and a sub-network obtained by pruning the target convolutional neural network is more complex.

In addition, in this embodiment of this application, when the value of the first sub-loss function does not reach the preset threshold (which may be referred to as the first threshold), the value of the dynamic weight is obtained based on the value of the first sub-loss function. In this embodiment of this application, the dynamic weight may be represented by λ(xᵢ,θ), and the first threshold may be represented by C. Similarly, xᵢ is the input training sample, and θ is the network parameter of the entire target convolutional neural network. λ(·) is an expression of the dynamic weight, and the dynamic weight may also be referred to as an adaptive penalty weight, which may be specifically defined as shown in the following formula (1):

$$λ ( {x}_{i} , θ ) = {λ}^{′} \cdot \frac{C - {ℒ}_{ce} ( {x}_{i} , θ )}{c} , and \qquad ( 1 )$$

$${ℒ}_{ce} ( {x}_{i} , θ ) \leq C$$

λ′ is a set trade-off coefficient (which is a hyperparameter and may be referred to as a second preset coefficient); C is the preset threshold (which may be referred to as the first threshold); [symbol] _{ce}(xᵢ, θ) is the value of the first sub-loss function for the training sample xᵢ; C− [symbol] _{ce}(xᵢ, θ) represents a difference between the first threshold C and the first sub-loss function [symbol] _{ce}(xᵢ, θ), where the difference may be referred to as a first difference; and

$$\frac{C - {ℒ}_{ce} ( {x}_{i} , θ )}{C}$$

may be referred to as a first ratio. In the formula (1), [symbol] _{ce}(xᵢ, θ)≤C indicates that the value of the first sub-loss function for the training sample xᵢ does not exceed the first threshold C. This indicates that the training sample xᵢ is not complex, and corresponding pruning may be performed on the target convolutional neural network.

In addition, it can be learned from the foregoing formula (1) that because

$${ℒ}_{ce} ( {x}_{i} , θ ) \leq C , 0 < \frac{C - {ℒ}_{ce} ( {x}_{i} , θ )}{C} < 1 ,$$

that is, 0<λ(xᵢ, θ)<λ′. Therefore, the value of λ(xᵢ, θ) is related to [symbol] _{ce}(xᵢ, θ), that is, λ(xᵢ, θ) is obtained based on [symbol] _{ce}(xᵢ, θ). In addition, because the value of [symbol] _{ce}(xᵢ, θ) may reflect complexity of the input training sample xᵢ, high complexity of the input training sample xᵢ indicates a large value of [symbol] _{ce}(xᵢ, θ). In this case, a value of

$$\frac{C - {ℒ}_{ce} ( {x}_{i} , θ )}{C}$$

is small. Because λ′ is the hyperparameter, λ(xᵢ, θ) is small. It can be learned that when the value of the first sub-loss function [symbol] _{ce}(xᵢ, θ) does not reach the first threshold (that is, [symbol] _{ce}(xᵢ, θ)≤C), the value of the dynamic weight is in the inverse correlation with the value of the first sub-loss function.

Based on the foregoing description, because the second sub-loss function is obtained based on the channel importance function and the dynamic weight, in some implementations of this application, the second sub-loss function may be specifically obtained by multiplying the channel importance function by the dynamic weight, and an expression of the second sub-loss function may be represented in the following formula (2):

λ(xᵢ,θ)·Σᵢ₌₁^{L}∥πⁱ(xᵢ)∥₁ (2)

∥·∥₁ represents a [symbol] ₁ norm, ∥π^{l}(xᵢ)∥₁≥0 is always true, and λ(xᵢ, θ) is shown in the foregoing formula (1). Details are not described herein again.

Operation 303: The training device obtains an objective loss function based on the first sub-loss function and the second sub-loss function.

After determining the expression of the first sub-loss function and the expression of the second sub-loss function, the training device may obtain the objective loss function based on the first sub-loss function and the second sub-loss function. Specifically, in some implementations of this application, the objective loss function may be obtained by adding the first sub-loss function and the second sub-loss function. Therefore, in this embodiment of this application, an expression of the objective loss function may be represented in the following formula (3):

$${L}_{T} = {min}_{θ} ( {\sum }_{i = 1}^{N} ( {ℒ}_{ce} ( {x}_{i} , θ ) + λ ( {x}_{i} , θ ) \cdot {\sum }_{l = 1}^{L} {‖ {π}^{l} ( {x}_{i} ) ‖}_{1} ) ) \qquad ( 3 )$$

N is a total quantity of training samples in the training set, xᵢ is the currently input training sample, [symbol] _{ce}(xᵢ, θ) is the first sub-loss function, and λ(xᵢ, θ)·Σᵢ₌₁^{L}∥π^{l}(xᵢ)∥₁ is the second sub-loss function. In a case of [symbol] _{ce}(xᵢ, θ)≤C, λ(xᵢ, θ) is shown in the foregoing formula (1), and min_{θ} represents that an objective loss function for the N input training samples is minimized.

It can be learned from the foregoing formula (1) to formula (3) that, in the case of [symbol] _{ce}(xᵢ, θ)≤C, a large value of [symbol] _{ce}(xᵢ, θ) reflects a complex input training sample. In this case, the value of

$$\frac{C - {ℒ}_{ce} ( {x}_{i} , θ )}{C}$$

is small, it λ(xᵢ, θ) is also small, and a proportion of Σₗ₌₁^{L}∥π^{l}(xᵢ)∥₁ in the objective loss function L_{T} represented by formula (3) is small. This indicates that a value of Σₗ₌₁^{L}∥π^{l}(xᵢ)∥₁ is not important, and pruning may not be performed. On the contrary, a simple input training sample indicates a large value of λ(xᵢ, θ). This indicates that the value of Σₗ₌₁^{L}∥π^{l}(xᵢ)∥₁ has great impact on the entire objective loss function L_{T}. Because Σₗ₌₁^{L}∥π^{l}(xᵢ)∥₁ may reflect complexity of a network, a small value of Σₗ₌₁^{L}∥π^{l}(xᵢ)∥₁ indicates that a sub-network that needs to be obtained is sparse, and that pruning needs to be performed.

In conclusion, a complex training sample input to the target convolutional neural network indicates a large value of the first sub-loss function, a small dynamic weight of the channel importance function, and a small proportion of the second sub-loss function in the entire objective loss function. In this case, less pruning (even no pruning) may be performed on the target convolutional neural network, and a sub-network (that is, the pruned target convolutional neural network) that is finally used to process the training sample is complex. A simple training sample input to the target convolutional neural network indicates a small value of the first sub-loss function, a large dynamic weight of the channel importance function, and a large proportion of the second sub-loss function in the entire objective loss function. In this case, more pruning may be performed on the target convolutional neural network (which has significant impact on the entire objective loss function), and a sub-network (that is, the pruned target convolutional neural network) that is finally used to process the training sample is simple.

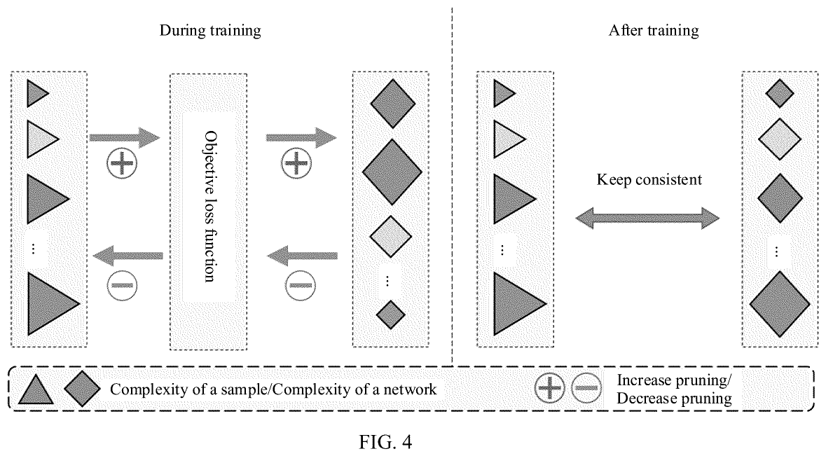

For ease of understanding, FIG. 4 is a schematic diagram of dynamically balancing complexity of a sample and complexity of a network in a convolutional neural network pruning processing method according to an embodiment of this application. Specifically, the complexity of the sample and the complexity of the network can be dynamically balanced by using the objective loss function constructed in embodiments of this application. When a more complex sample (as shown in FIG. 4, a larger triangle area indicates a more complex sample) is sent to the target network and a larger first sub-loss function (that is, a larger value of [symbol] _{ce}(xᵢ, θ) indicates a more complex sample) is generated, less corresponding pruning needs to be performed, and an obtained sub-network is more complex (as shown in FIG. 4, a larger diamond area indicates a more complex pruned network).

Operation 304: The training device performs sparse training on the target convolutional neural network by using the objective loss function to obtain a trained target convolutional neural network, where the sparsening is pruning a convolution kernel of the target convolutional neural network based on the value of the channel importance function.

After constructing the corresponding objective loss function, the training device may perform sparse training on the target convolutional neural network by using the objective loss function to obtain the trained target convolutional neural network. The sparsening is pruning the convolution kernel of the target convolutional neural network based on the value of the channel importance function, and is specifically pruning a convolution kernel whose value of an importance degree is less than the second threshold.

It should be noted that, in some implementations of this application, a plurality of manners may be used to determine, based on the training sample, an extent to which the target convolutional neural network is trained by using the foregoing constructed objective loss function. The following provides some termination conditions for stopping training the target convolutional neural network, including but not limited to the following.

(1) The Objective Loss Function Reaches the Preset Threshold.

After the objective loss function is constructed in the foregoing manner, a threshold (for example, 0.03) may be set for the objective loss function in advance. In a process of performing iterative sparse training on the target convolutional neural network, after each training is completed, it is determined whether a value that is obtained in a current round of training and that is of the objective loss function reaches the threshold. If the value does not reach the threshold, the training continues, or if the value reaches the preset threshold, the training ends. In this case, a value of a network parameter of the target convolutional neural network that is determined in the current round of training is used as a value of a network parameter of the finally trained target convolutional neural network.

(2) The Objective Loss Function Begins to Converge.

After the objective loss function is constructed in the foregoing manner, iterative sparse training may be performed on the target convolutional neural network. If a difference between a value that is obtained in a current round of training and that is of the objective loss function and a value that is obtained in a previous round of training and that is of the objective loss function falls within a preset range (for example, within 0.01), it is considered that the objective loss function converges, and the training may be terminated. In this case, a value of a network parameter of the target convolutional neural network that is determined in the current round of training is used as a value of a network parameter of the finally trained target convolutional neural network.

(3) The Training Reaches a Preset Quantity of Times.

In this manner, a quantity of iterations (for example, 1000 times) for performing sparse training on the target convolutional neural network may be preconfigured. After the objective loss function is constructed in the foregoing manner, iterative sparse training may be performed on the target convolutional neural network. After each round of training ends, a value of a network parameter of the target convolutional neural network that corresponds to the round is stored until a quantity of iterations of sparse training reaches the preset quantity of times. Then, the target convolutional neural network obtained in each round may be verified by using test data. A value of a network parameter with best performance is selected as a value of a final network parameter of the target convolutional neural network, or a network parameter of a target convolutional neural network that is obtained through last training is used as the value of the final network parameter of the target convolutional neural network.

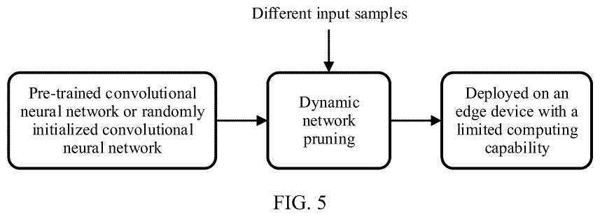

Finally, in some implementations of this application, the target convolutional neural network obtained through sparse training may be deployed on a target device, for example, may be deployed on an edge device with a limited computing capability, such as a mobile phone or an intelligent wearable device (for example, a smart band or a smart watch). For example, as shown in FIG. 5, when a pre-trained convolutional neural network or a randomly initialized convolutional neural network needs to be deployed on the edge device with the limited computing capability, a network computing amount can be reduced by using the convolutional neural network pruning processing method provided in this embodiment of this application. In this way, an inference process on the edge device is accelerated. In the convolutional neural network pruning processing method provided in this embodiment of this application, dynamic pruning can be implemented for each input sample.

It should be noted that, in the foregoing embodiment, a method for constructing the objective loss function when the value of the first sub-loss function does not reach the first threshold (that is, [symbol] _{ce}(xᵢ, θ)≤C) is described. In some other implementations of this application, if the value of the first sub-loss function reaches the first threshold (that is, [symbol] _{ce}(xᵢ, θ)>C), it is considered that a corresponding training sample is a complex sample. In this case, the value of the dynamic weight is 0, that is, shown in the following formula (4):

λ(xᵢ,θ)=0, and [symbol] _{ce}(xᵢ,θ)>C (4)

Because when [symbol] _{ce}(xᵢ, θ)>C, λ(xᵢ, θ)=0, and the second sub-loss function is also 0. It represents that when the training sample is the complex sample, the target convolutional neural network does not need to be pruned. Otherwise, a prediction result is affected. In this case, the constructed objective loss function may be shown in the following formula (5):

$${L}_{T} = {min}_{θ} ( {\sum }_{i = 1}^{N} {ℒ}_{ce} ( {x}_{i} , θ ) ) \qquad ( 5 )$$

In conclusion, for any input training sample, a variable β may be defined, and the variable β may be shown in the following formula (6):

$${β}_{i} = \{ \begin{matrix}1 , & {ℒ}_{ce} ( {x}_{i} , θ ) \leq C , \\ 0 , & {ℒ}_{ce} ( {x}_{i} , θ ) > C .\end{matrix} \qquad ( 6 )$$

Then, the dynamic weight may be shown in the following formula (7):

$$λ ( {x}_{i} , θ ) = {λ}^{′} \cdot {β}_{i} \frac{C - {ℒ}_{ce} ( {x}_{i} , θ )}{C} \qquad ( 7 )$$

Therefore, the constructed objective loss function may be shown in the following formula (8):

$$\begin{matrix}{L}_{T} = {min}_{θ} ( {\sum }_{i = 1}^{N} ( {ℒ}_{ce} ( {x}_{i} , θ ) + λ ( {x}_{i} , θ ) \cdot {\sum }_{l = 1}^{L} {‖ {π}^{l} ( {x}_{i} ) ‖}_{1} ) ) \\ = {min}_{θ} ( {\sum }_{i = 1}^{N} {ℒ}_{ce} ( {x}_{i} , θ ) + {λ}^{′} \cdot {\sum }_{l = 1}^{L} \\ ( {β}_{i} ( \frac{C - {ℒ}_{ce} ( {x}_{i} , θ )}{C} ) \cdot {\sum }_{l = 1}^{L} {‖ {π}^{l} ( {x}_{i} ) ‖}_{1} ) )\end{matrix} \qquad ( 8 )$$

In conclusion, in the foregoing embodiment, sparse training is performed on the convolutional neural network by constructing the new objective loss function. The newly constructed objective loss function includes two sub-loss functions. The first sub-loss function is used to measure complexity of the training sample, and the second sub-loss function is used to measure complexity of a pruned sub-network that processes the training sample. The complexity of the network is obtained based on the channel importance function and the dynamic weight. When the value of the first sub-loss function does not reach the first threshold, the complexity of the training sample is high, the value of the dynamic weight is small (inverse correlation), sparsity of the channel importance function obtained through training is small, and less pruning is performed. In other words, in a pruning process, the complexity of the sample is fully utilized to customize a corresponding sub-network structure for each training sample. In this way, each training sample is flexibly pruned. Redundancy in the convolutional neural network can be mined to a maximum extent, so that a training sample with high complexity is input to a sub-network with a large capacity for prediction.

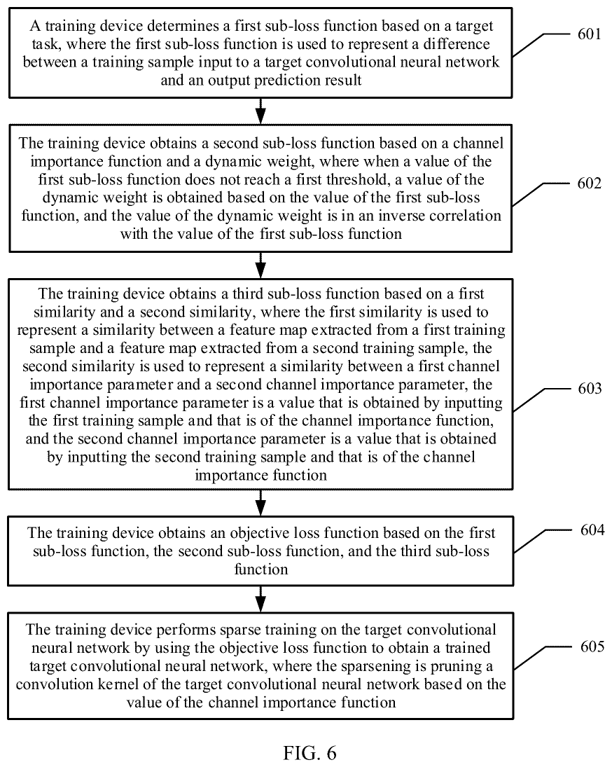

In addition, in some implementations of this application, in addition to the complexity of the sample, both the complexity of the sample and a similarity between samples may be further considered. In other words, it is not only expected that the training sample with the high complexity is input to the sub-network with the large capacity for prediction, but also expected that similar training samples can be input to similar sub-networks (that is, similar pruning is performed) for prediction. FIG. 6 is another schematic flowchart of a convolutional neural network pruning processing method according to an embodiment of this application. The method may specifically include the following operations.

Operation 601: A training device determines a first sub-loss function based on a target task, where the first sub-loss function represents a difference between a training sample input to a target convolutional neural network and an output prediction result.

Operation 602: The training device obtains a second sub-loss function based on a channel importance function and a dynamic weight, where when a value of the first sub-loss function does not reach a first threshold, a value of the dynamic weight is obtained based on the value of the first sub-loss function, and the value of the dynamic weight is in an inverse correlation with the value of the first sub-loss function.

In this embodiment of this application, operation 601 and operation 602 are similar to operation 301 and operation 302 in the foregoing embodiment. For details, refer to operation 301 and operation 302. Details are not described herein again.

Operation 603: The training device obtains a third sub-loss function based on a first similarity and a second similarity, where the first similarity represents a similarity between a feature map extracted from a first training sample and a feature map extracted from a second training sample, the second similarity represents a similarity between a first channel importance parameter and a second channel importance parameter, the first channel importance parameter is a value that is obtained by inputting the first training sample and that is of the channel importance function, and the second channel importance parameter is a value that is obtained by inputting the second training sample and that is of the channel importance function.

In addition to that the sample is mapped to complexity space, a similarity between training samples may also help customize proper sub-network structures for different training samples. In other words, it is expected that similar training samples may be input to similar sub-networks. Therefore, in addition to determining the first sub-loss function based on the target task and obtaining the second sub-loss function based on the channel importance function and the dynamic weight, the training device may further obtain a third sub-loss function based on a first similarity and a second similarity. The first similarity represents a similarity between a feature map extracted from a first training sample and a feature map extracted from a second training sample, and the second similarity represents a similarity between a first channel importance parameter and a second channel importance parameter. The first channel importance parameter is a value that is obtained by inputting the first training sample and that is of the channel importance function, and specifically represents an importance degree that is of each convolution kernel in the target convolutional neural network and that is on the first training sample. The second channel importance parameter is a value that is obtained by inputting the second training sample and that is of the channel importance function, and specifically represents an importance degree that is of each convolution kernel in the target convolutional neural network and that is on the second training sample. The first training sample and the second training sample are separately any two samples in a training set.

Specifically, in this embodiment of this application, a middle-layer feature map F^{l}(xᵢ) generated by using the convolutional neural network for a training sample is used as a representation of the training sample xᵢ, and a channel importance function π^{l}(xᵢ) is used as a representation of a network structure. A representation form of a similarity between different sub-networks may be represented by using the following formula (9):

$${T}^{i} [ i , j ] = \frac{{π}^{l} ( {x}_{i} ) \cdot {π}^{l} ( {x}_{j} )}{{‖ {π}^{l} ( {x}_{i} ) ‖}_{2} \cdot {‖ {π}^{l} ( {x}_{j} ) ‖}_{2}} \qquad ( 9 )$$

l represents any layer of the target convolutional neural network, that is, l∈[1, L]; L is a total quantity of layers of the target convolutional neural network; xᵢ is the input first training sample; xᵢ is the input second training sample; and T^{l}[i,j] is the foregoing second similarity, and may be specifically used to represent a cosine similarity between a first channel importance parameter π^{l}(xᵢ) and a second channel importance parameter π^{l}(xᵢ). It should be noted that, that the second similarity is represented as the cosine similarity is merely an example. In some other implementations of this application, the second similarity may alternatively be represented as another similarity. Examples are not provided herein again.

In addition, a representation form of a similarity between feature maps output by layers of the target convolutional neural network for different training samples may be represented by using the following formula (10):

$${R}^{l} [ i , j ] = \frac{p ( {F}^{l} ( {x}_{i} ) ) \cdot p ( {F}^{l} ( {x}_{j} ) )}{{‖ p ( {F}^{l} ( {x}_{i} ) ) ‖}_{2} \cdot {‖ p ( {F}^{l} ( {x}_{j} ) ) ‖}_{2}} \qquad ( 10 )$$

l represents any layer of the target convolutional neural network, that is, l∈[1, L]; L is the total quantity of layers of the target convolutional neural network; xᵢ is the input first training sample; xⱼ is the input second training sample; p(·) is a pooling operation (for example, average pooling or maximum pooling); and R^{l}[i,j] is the foregoing first similarity, and may be specifically used to represent a cosine similarity between a feature map F^{l}(xᵢ) extracted from the first training sample and a feature map F^{l}(xⱼ) extracted from the second training sample. It should be noted that, that the first similarity is represented as the cosine similarity is merely an example. In some other implementations of this application, the first similarity may alternatively be represented as another similarity. Examples are not provided herein again.

Based on the foregoing formula (9) and formula (10), in some implementations of this application, a specific implementation of obtaining the third sub-loss function based on the first similarity and the second similarity may be: after the first similarity R^{l}[i, j] and the second similarity T^{l}[i, j] are separately converted into one-dimensional vectors (for example, the pooling operation), using a distance function between the first similarity R^{l}[i, j] and the second similarity T^{l}[i, j] as the third sub-loss function, which may be specifically represented by using the following formula (11):

$${ℒ}_{sim} ( 𝒳 , θ ) = {\sum }_{l = 1}^{L} dis ( {T}^{l} , {R}^{l} ) \qquad ( 11 )$$

l represents any layer of the target convolutional neural network, that is, l∈[1, L]; L is the total quantity of layers of the target convolutional neural network; [symbol] ₛᵢₘ( [symbol] , θ) is the third sub-loss function; and dis(T^{l}, R^{l}) is the distance function between the first similarity R^{l}[i,j] and the second similarity T^{l}[i, j].

It should be noted that, in some implementations of this application, a last-layer feature map F^{L}(xᵢ) generated by the convolutional neural network for the training sample may be used as the representation of the training sample xᵢ, and a last-layer channel importance parameter π^{L}(xᵢ) is used as the representation of the network structure. In this case, the representation form of the similarity between different sub-networks may be represented by using the following formula (12):

$${T}^{L} [ i , j ] = \frac{{π}^{L} ( {x}_{i} ) \cdot {π}^{L} ( {x}_{j} )}{{‖ {π}^{L} ( {x}_{i} ) ‖}_{2} \cdot {‖ {π}^{L} ( {x}_{j} ) ‖}_{2}} \qquad ( 12 )$$

L is a last layer of the target convolutional neural network; xᵢ is the input first training sample; xⱼ is the input second training sample; and T^{L}[i, j] is the foregoing second similarity, and may be specifically used to represent a cosine similarity between a first channel importance parameter π^{L}(xᵢ) and a second channel importance parameter π^{L}(xⱼ).

Similarly, a representation form of a similarity between feature maps output by the last layer of the target convolutional neural network for different training samples may be represented by using the following formula (13):

$${R}^{L} [ i , j ] = \frac{p ( {F}^{L} ( {x}_{i} ) ) \cdot p ( {F}^{L} ( {x}_{j} ) )}{{‖ p ( {F}^{L} ( {x}_{i} ) ) ‖}_{2} \cdot {‖ p ( {F}^{L} ( {x}_{j} ) ) ‖}_{2}} \qquad ( 13 )$$

L is the last layer of the target convolutional neural network; xᵢ is the input first training sample; xᵢ is the input second training sample; p(·) is the pooling operation (for example, average pooling or maximum pooling); and R^{L}[i, j] is the foregoing first similarity, and may be specifically used to represent a cosine similarity between a last-layer feature map F^{L}(xᵢ) extracted from the first training sample and a last-layer feature map F^{L}(xⱼ) extracted from the second training sample.

Based on the foregoing formula (12) and formula (13), in some implementations of this application, a specific implementation of obtaining the third sub-loss function based on the first similarity and the second similarity may be represented by using the following formula (14):

[symbol]

ₛᵢₘ( [symbol] ,θ)=dis(T^{L},R^{L}) (14)

L is the last layer of the target convolutional neural network; [symbol] ₛᵢₘ( [symbol] , θ) is the third sub-loss function; and dis(T^{L}, R^{L}) is a distance function between the first similarity R^{L}[i,j] and the second similarity T^{L}[i, j].

It should be noted that, in this embodiment of this application, operations of obtaining, by the training device, the second sub-loss function and the third sub-loss function may not be fixed. In other words, the training device may perform operation 602 before performing operation 603. Alternatively, the training device may perform operation 603 before performing operation 602. Alternatively, the training device may perform operation 602 and operation 603 at the same time. This is not specifically limited in this application.

Operation 604: The training device obtains the objective loss function based on the first sub-loss function, the second sub-loss function, and the third sub-loss function.

After determining the expression of the first sub-loss function, the expression of the second sub-loss function, and an expression of the third sub-loss function, the training device may obtain the objective loss function based on the first sub-loss function, the second sub-loss function, and the third sub-loss function. Specifically, in some implementations of this application, the objective loss function may be obtained by adding the first sub-loss function, the second sub-loss function, and a first product result, where the first product result is a result obtained by multiplying the third sub-loss function by a preset coefficient (which may be referred to as a first preset coefficient γ). Therefore, in this embodiment of this application, an expression of the objective loss function may be represented in the following formula (15):

$${L}_{T} = {min}_{θ} ( {\sum }_{i = 1}^{N} ( {ℒ}_{ce} ( {x}_{i} , θ ) + λ ( {x}_{i} , θ ) \cdot {\sum }_{l = 1}^{L} {‖ {π}^{l} ( {x}_{i} ) ‖}_{1} ) ) + γ \cdot {ℒ}_{sim} ( 𝒳 , θ ) ) \qquad ( 15 )$$

N is the total quantity of training samples in the training set, xᵢ is the currently input training sample, [symbol] _{ce}(xᵢ, θ) is the first sub-loss function, λ(xᵢ, θ)·Σₗ₌₁^{L}∥π^{l}(xᵢ)∥₁ is the second sub-loss function, [symbol] ₛᵢₘ( [symbol] , θ) is the third sub-loss function, and γ is the first preset coefficient (which is a hyperparameter).

Operation 605: The training device performs sparse training on the target convolutional neural network by using the objective loss function to obtain a trained target convolutional neural network, where the sparsening is pruning a convolution kernel of the target convolutional neural network based on the value of the channel importance function.

In this embodiment of this application, operation 605 is similar to operation 304 in the foregoing embodiment. For details, refer to operation 304. Details are not described herein again.

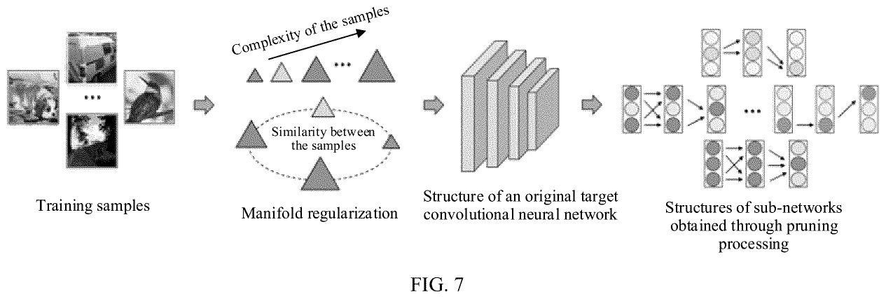

In conclusion, the convolutional neural network pruning processing method in the embodiment corresponding to FIG. 6 explores the similarity between the samples from two perspectives of the complexity of the sample and the similarity between the samples, to mine network redundancy corresponding to any instance to a maximum extent. FIG. 7 shows a corresponding sub-network structure customized for each training sample by using manifold information of a training sample according to an embodiment of this application. The manifold information includes two angles: complexity of the sample and a similarity between samples. The pruning processing method is a dynamic pruning method, and a dynamic network with a fast inference speed is obtained by deleting different convolution kernels for different input data. The network may be more conveniently deployed to a device (such as a mobile phone, a watch, or a robot) with a limited computing capability to process a related target task (such as classification, segmentation, and detection) such as an image, a text, and a voice.

It should be noted that, in some implementations of this application, pruning processing may alternatively be performed by considering only the similarity between the samples. A processing manner is similar to a processing manner in which the similarity between the samples is considered in FIG. 6. Details are not described herein again.

2. Inference Phase

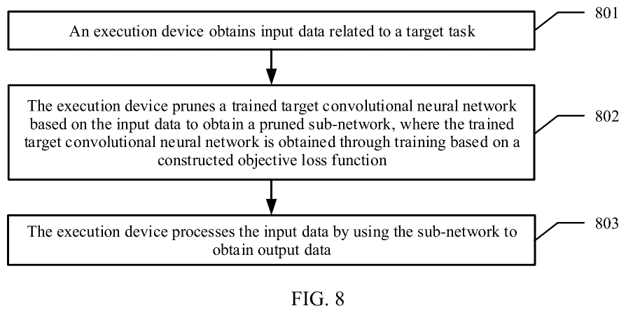

In this embodiment of this application, the inference phase is a process in which the execution device 210 processes the target task by using the trained convolutional neural network 201 in FIG. 2. FIG. 8 is a schematic flowchart of a data processing method according to an embodiment of this application. The method may specifically include the following operations.

Operation 801: An execution device obtains input data related to a target task.

First, the execution device obtains the to-be-processed input data, where the input data is related to the to-be-processed target task. For example, when the target task is a classification task, the input data is data used for classification.

It should be noted that in this embodiment of this application, the input data may be image data, audio data, or text data, and a data type of the input data is determined by a to-be-processed target task. This is not specifically limited herein.

Operation 802: The execution device prunes a trained target convolutional neural network based on the input data to obtain a pruned sub-network, where the trained target convolutional neural network is obtained through training based on a constructed objective loss function.

Then, the execution device prunes the trained target convolutional neural network based on the input data and a pruning rate to obtain the pruned sub-network, where the trained target convolutional neural network is obtained through training based on the objective loss function constructed in the embodiment corresponding to FIG. 3 or the embodiment corresponding to FIG. 6.

For example, if the trained target convolutional neural network is obtained through training based on the objective loss function constructed in the embodiment corresponding to FIG. 3, the objective loss function may be specifically obtained based on a first sub-loss function and a second sub-loss function. The first sub-loss function is determined based on the target task, and the second sub-loss function is determined based on a channel importance function and a dynamic weight. The first sub-loss function represents a difference between a training sample input to the target convolutional neural network and an output prediction result. When a value of the first sub-loss function does not reach a first threshold, a value of the dynamic weight is obtained based on the value of the first sub-loss function. The value of the dynamic weight is in an inverse correlation with the value of the first sub-loss function. Specifically, in some implementations of this application, the dynamic weight may be represented by λ(xᵢ, θ), and the first threshold may be represented by C. Similarly, xᵢ is the input training sample, θ is a network parameter of the entire target convolutional neural network, and λ(·) is an expression of the dynamic weight. An implementation in which the value of the dynamic weight λ(xᵢ, θ) is obtained based on the value of the first sub-loss function may be: In a case of [symbol] _{ce}(xᵢ, θ)≤C, the value of the dynamic weight λ(xᵢ, θ) is obtained by multiplying a first ratio

$$\frac{C - {ℒ}_{ce} ( {x}_{i} , θ )}{C}$$

by a second preset coefficient λ′. The first ratio

$$\frac{C - {ℒ}_{ce} ( {x}_{i} , θ )}{C}$$

is a ratio or a rust difference C− [symbol] _{ce}(xᵢ, θ) to the first threshold C, and the first difference C− [symbol] _{ce}(xᵢ, θ) is a difference between the first threshold C and the value of the first sub-loss function [symbol] _{ce}(xᵢ, θ). In some other implementations of this application, when the value of the first sub-loss function reaches the first threshold (that is, [symbol] _{ce}(xᵢ, θ)>C), the value of the dynamic weight is 0 (that is, λ(xᵢ, θ)=0).

For another example, if the trained target convolutional neural network is obtained through training based on the objective loss function constructed in the embodiment corresponding to FIG. 6, the objective loss function may be specifically obtained based on a first sub-loss function, a second sub-loss function, and a third sub-loss function. The first sub-loss function is determined based on the target task, the second sub-loss function is determined based on a channel importance function and a dynamic weight, and the third sub-loss function is determined based on a first similarity and a second similarity. The first sub-loss function represents a difference between a training sample input to the target convolutional neural network and an output prediction result. When a value of the first sub-loss function does not reach a first threshold, a value of the dynamic weight is obtained based on the value of the first sub-loss function. The value of the dynamic weight is in an inverse correlation with the value of the first sub-loss function. The first similarity represents a similarity between a feature map extracted from a first training sample and a feature map extracted from a second training sample, and the second similarity represents a similarity between a first channel importance parameter and a second channel importance parameter. The first channel importance parameter is a value that is obtained by inputting the first training sample and that is of the channel importance function, and the second channel importance parameter is a value that is obtained by inputting the second training sample and that is of the channel importance function. The first training sample and the second training sample are any two different samples in a training set.

In this embodiment of this application, for details about how the trained target convolutional neural network is obtained through training based on the constructed objective loss function, refer to related description in embodiments corresponding to FIG. 3 and FIG. 6. Details are not described herein again.

It should be noted that, in some implementations of this application, a specific implementation of pruning, by the execution device, the trained target convolutional neural network based on the input data to obtain the pruned sub-network may alternatively be: pruning the trained target convolutional neural network based on the input data and the pruning rate to obtain the pruned sub-network, where the pruning rate is a proportion of a pruned convolution kernel to all convolution kernels in the target neural network. In this embodiment of this application, the pruning rate is a proportion of the pruned convolution kernel to all the convolution kernels in the target convolutional neural network. For example, it is assumed that there are 100 convolution kernels in the target convolutional neural network (that is, a quantity of channels is 100). If the pruning rate is 30%, 30 channels need to be pruned, and the network can be dynamically pruned for different input data by using the method and based on a learned channel importance function π^{l}(xᵢ).

For ease of understanding of the foregoing operation 802, an example is used in the following: It is assumed that N pieces of input data {xᵢ}ᵢ₌₁^{N} are given, and average importance of the convolution kernels (that is, the channels) in the trained target convolutional neural network for different input data is denoted as π̅^{l}={π̅^{l}[1], π̅^{l}[2], . . . , π̅^{l}[c^{l}]}. c^{l} is a quantity of channels at an l^{th} layer of the target convolutional neural network. For example, N=100, each piece of input data corresponds to one piece of channel importance π^{l}(xᵢ), and there are 100 pieces of π^{l}(xᵢ) in total. An average value is first obtained for the 100 pieces of π^{l}(xᵢ) to obtain π̅^{l}. π̅^{l} is a one-dimensional vector including l elements, and each element corresponds to one convolution kernel (that is, a channel). The elements of π̅^{l} are sorted as π̅^{l}[1]≤π̅^{l}[2]≤ . . . ≤π̅^{l}[c^{l}], and a threshold ξ^{l}=π^{l}[┌ηc^{l}┐] may be obtained, where η is a predefined pruning rate (for example, if the quantity of channels is 100 and the pruning rate is 30%, 30 channels need to be pruned). In the inference process, only a channel whose value of the channel importance function is larger than the threshold ξ^{l} needs to be retained. A channel whose value of the channel importance function is smaller than the threshold ξ^{l} is pruned, which means that a feature corresponding to the channel is a redundant feature and may be skipped. Based on the threshold ξ^{l}, different input data corresponds to different actual pruning manners of the network, and finally, networks with different calculation costs for different input data may be obtained.

Operation 803: The execution device processes the input data by using the sub-network to obtain output data.

Finally, the execution device processes the input data by using the sub-network obtained through pruning processing to obtain the output data (that is, the prediction result).

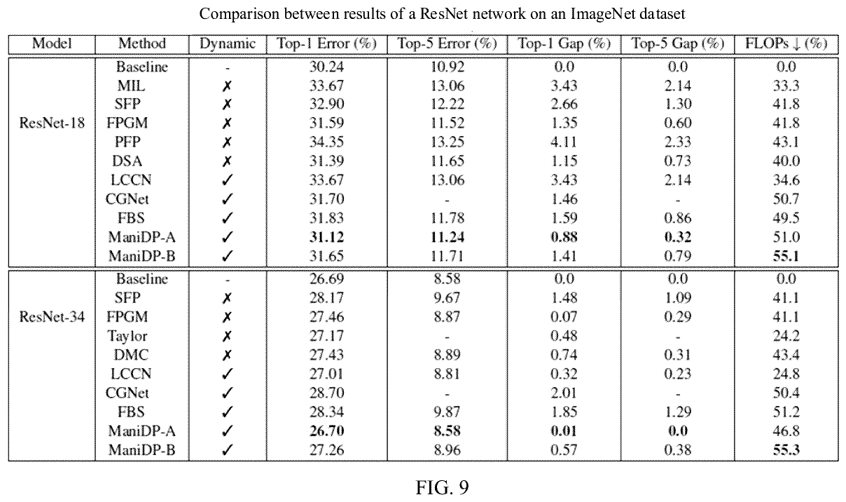

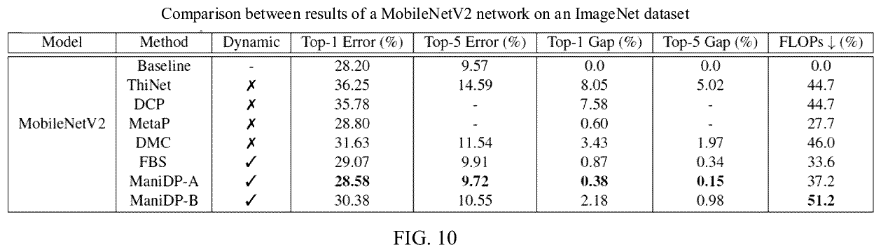

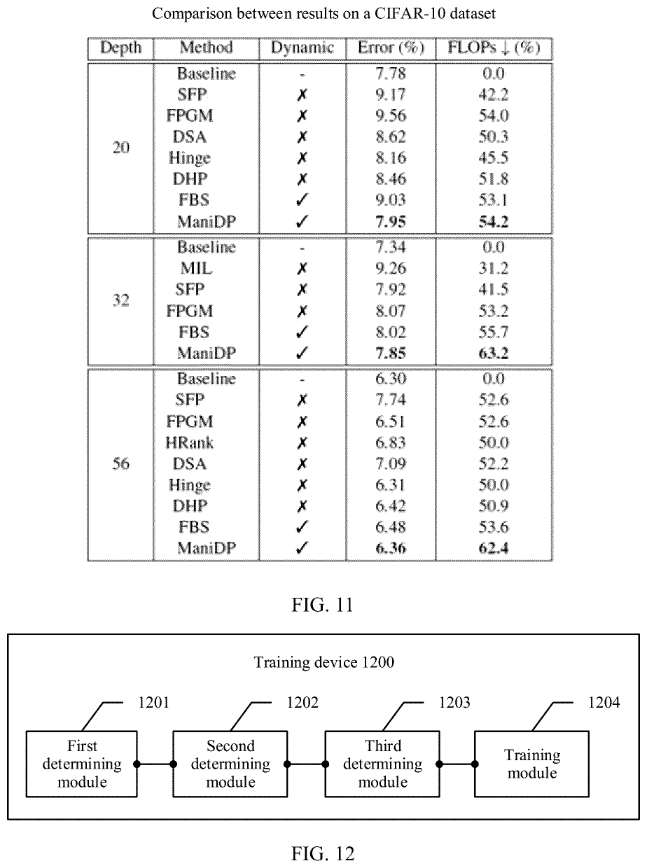

To have more intuitive understanding of beneficial effects brought by embodiments of this application, the following further compares technical effects brought by embodiments of this application. Specifically, the pruning method in this application is compared with an existing pruning method. Experimental results are shown in FIG. 9, FIG. 10, and FIG. 11. FIG. 9 is a diagram of comparison between results, obtained through classification by using a pruning method according to this application, of a ResNet network on an ImageNet dataset, and results, obtained through classification by using an existing pruning method, of the ResNet network on the ImageNet dataset. FIG. 10 is a diagram of comparison between results, obtained through classification by using a pruning method according to this application, of a MobileNetV2 network on an ImageNet dataset, and results, obtained through classification by using an existing pruning method, of the MobileNetV2 network on the ImageNet dataset. FIG. 11 is a diagram of comparison between results of a pruning method according to this application on a CIFAR-10 dataset and results of an existing pruning method on the CIFAR-10 dataset. Both ManiDP-A and ManiDP-B in FIG. 9 to FIG. 11 are methods in this application, and correspond to different pruning rates, where the pruning rate of ManiDP-A is less than the pruning rate of ManiDP-B.

Based on the foregoing embodiments, the following further provides a related device used to implement the solutions, to better implement the solutions in embodiments of this application. FIG. 12 is a schematic diagram of a training device according to an embodiment of this application. The training device 1200 may specifically include a first determining module 1201, a second determining module 1202, a third determining module 1203, and a training module 1204. The first determining module 1201 is configured to determine a first sub-loss function based on a target task. The first sub-loss function represents a difference between a training sample input to a target convolutional neural network and an output prediction result, the target convolutional neural network is a convolutional neural network used for training, the target convolutional neural network has different network parameters and loss functions in training processes for different training samples, and the training sample is any sample in a training set. The second determining module 1202 is configured to obtain a second sub-loss function based on a channel importance function and a dynamic weight. When a value of the first sub-loss function does not reach a first threshold, a value of the dynamic weight is obtained based on the value of the first sub-loss function. The value of the dynamic weight is in an inverse correlation with the value of the first sub-loss function. The third determining module 1203 is configured to obtain an objective loss function based on the first sub-loss function and the second sub-loss function. The training module 1204 is configured to perform sparse training on the target convolutional neural network by using the objective loss function to obtain a trained target convolutional neural network. The sparsening is pruning a convolution kernel of the target convolutional neural network based on a value of the channel importance function.

In an embodiment, the third determining module 1203 is specifically configured to add the first sub-loss function and the second sub-loss function to obtain the objective loss function.

In an embodiment, the second determining module 1202 is further configured to obtain a third sub-loss function based on a first similarity and a second similarity. The first similarity represents a similarity between a feature map extracted from a first training sample and a feature map extracted from a second training sample, and the second similarity represents a similarity between a first channel importance parameter and a second channel importance parameter. The first channel importance parameter is a value that is obtained by inputting the first training sample and that is of the channel importance function, and the second channel importance parameter is a value that is obtained by inputting the second training sample and that is of the channel importance function. The first training sample and the second training sample are any two different samples in the training set.

In this case, the third determining module 1203 is further specifically configured to obtain the objective loss function based on the first sub-loss function, the second sub-loss function, and the third sub-loss function.

In an embodiment, the second determining module 1202 is further specifically configured to: after separately converting the first similarity and the second similarity into one-dimensional vectors, use a distance function between the first similarity and the second similarity as the third sub-loss function.

In an embodiment, the first similarity specifically represents a cosine similarity between the feature map extracted from the first training sample and the feature map extracted from the second training sample; and the second similarity specifically represents a cosine similarity between the first channel importance parameter and the second channel importance parameter.

In an embodiment, the third determining module 1203 is further specifically configured to add the first sub-loss function, the second sub-loss function, and a first product result to obtain the objective loss function. The first product result is a result obtained by multiplying the third sub-loss function by a first preset coefficient.

In an embodiment, that a value of the dynamic weight is obtained based on the value of the first sub-loss function includes: obtaining the value of the dynamic weight by multiplying a first ratio by a second preset coefficient. The first ratio is a ratio of a first difference to the first threshold, and the first difference is a difference between the first threshold and the value of the first sub-loss function.

In an embodiment, the second determining module 1202 is specifically configured to multiply the channel importance function by the dynamic weight to obtain the second sub-loss function.

In an embodiment, when the value of the first sub-loss function reaches the first threshold, the value of the dynamic weight is 0.

In an embodiment, the first determining module 1201 is specifically configured to: when the target task is a classification task, determine a cross-entropy loss function as the first sub-loss function.

In an embodiment, the training module 1204 is further configured to deploy the trained target convolutional neural network on a target device, for example, may be deployed on an edge device with a limited computing capability, such as a mobile phone or an intelligent wearable device (for example, a smart band or a smart watch).

It should be noted that content such as information exchange and an execution process between the modules/units in the training device 1200 is based on a same concept as the method embodiment corresponding to FIG. 3 or FIG. 6 in this application. For specific content, refer to the description in the foregoing method embodiments in this application. Details are not described herein again.

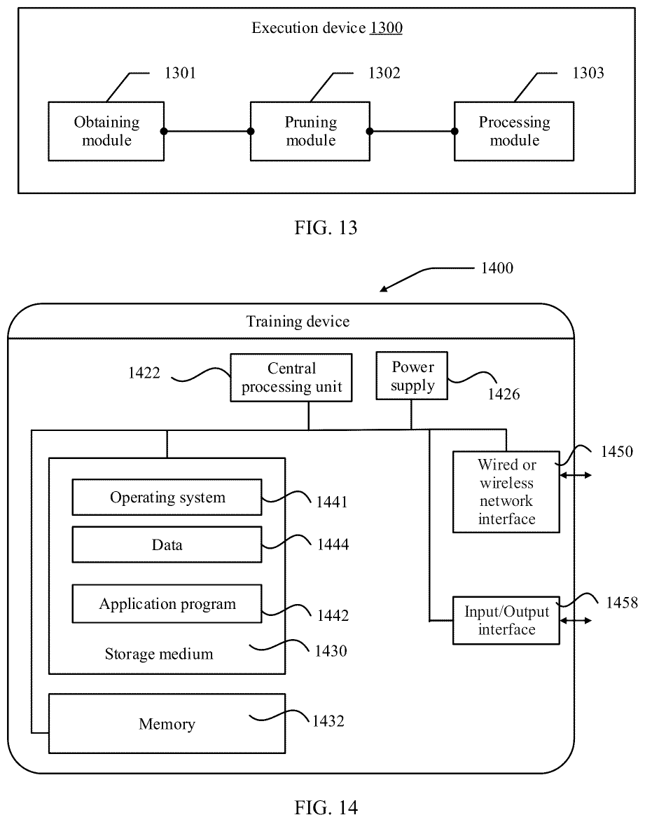

An embodiment of this application further provides an execution device. FIG. 13 is a schematic diagram of an execution device according to an embodiment of this application. The execution device 1300 may specifically include an obtaining module 1301, a pruning module 1302, and a processing module 1303. The obtaining module 1301 is configured to obtain input data related to a target task. The pruning module 1302 is configured to prune a trained target convolutional neural network based on the input data to obtain a pruned sub-network. The trained target convolutional neural network is obtained through training by using an objective loss function, the objective loss function is obtained based on a first sub-loss function and a second sub-loss function, the first sub-loss function is determined based on the target task, the second sub-loss function is determined based on a channel importance function and a dynamic weight, and the first sub-loss function represents a difference between a training sample input to the target convolutional neural network and an output prediction result. When a value of the first sub-loss function does not reach a first threshold, a value of the dynamic weight is obtained based on the value of the first sub-loss function. The value of the dynamic weight is in an inverse correlation with the value of the first sub-loss function, the objective loss function is used to perform sparsening on the target convolutional neural network during training of the target convolutional neural network, and the sparsening is pruning a convolution kernel of the target convolutional neural network based on a value of the channel importance function. The processing module 1303 is configured to process the input data by using the sub-network to obtain output data.

In an embodiment, the pruning module 1302 is specifically configured to prune the trained target convolutional neural network based on the input data and a pruning rate to obtain the pruned sub-network. The pruning rate is a proportion of the pruned convolution kernel to all convolution kernels in the target neural network.

In an embodiment, that a value of the dynamic weight is obtained based on the value of the first sub-loss function includes: obtaining the value of the dynamic weight by multiplying a first ratio by a second preset coefficient. The first ratio is a ratio of a first difference to the first threshold, and the first difference is a difference between the first threshold and the value of the first sub-loss function.

In an embodiment, when the value of the first sub-loss function reaches the first threshold, the value of the dynamic weight is 0.

In an embodiment, the input data may be any one of image data, audio data, or text data.

It should be noted that content such as information exchange and an execution process between the modules/units in the execution device 1300 is based on a same concept as the method embodiment corresponding to FIG. 8 in this application. For specific content, refer to the description in the foregoing method embodiments in this application. Details are not described herein again.

The following describes another training device provided in an embodiment of this application. FIG. 14 is a schematic diagram of a structure of a training device according to an embodiment of this application. The training device 1200 described in the embodiment corresponding to FIG. 12 may be deployed on the training device 1400, and is configured to implement a function of the training device 1200 in the embodiment corresponding to FIG. 12. Specifically, the training device 1400 is implemented by one or more servers. The training device 1400 may have a large difference due to different configurations or performance, and may include one or more central processing units (CPUs) 1422, a memory 1432, and one or more storage media 1430 (for example, one or more massive storage devices) that store an application program 1442 or data 1444. The memory 1432 and the storage medium 1430 may be transient storage or persistent storage. The program stored in the storage medium 1430 may include one or more modules (not shown in the figure), and each module may include a series of instruction operations for the training device 1400. Further, the central processing unit 1422 may be configured to: communicate with the storage medium 1430, and perform, on the training device 1400, the series of instruction operations in the storage medium 1430.

The training device 1400 may further include one or more power supplies 1426, one or more wired or wireless network interfaces 1450, one or more input/output interfaces 1458, and/or one or more operating systems 1441 such as Windows Server™, Mac OS X™, Unix™, Linux™ and FreeBSD™.

In this embodiment of this application, the central processing unit 1422 is configured to perform the convolutional neural network pruning processing method performed by the training device in the embodiment corresponding to FIG. 3 or FIG. 6. For example, the central processing unit 1422 may be configured to: first, determine a first sub-loss function based on a target task, where the first sub-loss function represents a difference between a training sample input to a convolutional neural network (that is, a target convolutional neural network) on which pruning processing is to be performed and an output prediction result. For example, when the target task is a classification task, the first sub-loss function may be a cross-entropy loss function. In addition to determining the first sub-loss function based on the target task, the central processing unit 1422 may further obtain a second sub-loss function based on a channel importance function and a dynamic weight; when a value of the first sub-loss function does not reach a preset threshold (which may be referred to as a first threshold), obtain a value of the dynamic weight based on the value of the first sub-loss function, where the value of the dynamic weight is in an inverse correlation with the value of the first sub-loss function; after determining an expression of the first sub-loss function and an expression of the second sub-loss function, obtain an objective loss function based on the first sub-loss function and the second sub-loss function; and finally, perform sparse training on the target convolutional neural network by using the objective loss function to obtain a trained target convolutional neural network.

It should be noted that a specific manner in which the central processing unit 1422 performs the foregoing operations is based on a same concept as the method embodiment corresponding to FIG. 3 or FIG. 6 in this application. Technical effects brought by the central processing unit 1422 are the same as those in the foregoing method embodiments of this application. For specific content, refer to the description in the foregoing method embodiments in this application. Details are not described herein again.

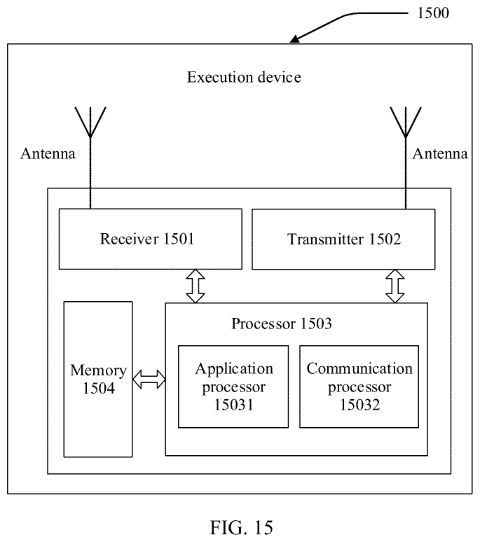

The following describes an execution device provided in an embodiment of this application. FIG. 15 is a schematic diagram of a structure of an execution device according to an embodiment of this application. The execution device 1500 may be specifically represented as various terminal devices, such as a virtual reality VR device, a mobile phone, a tablet computer, a notebook computer, an intelligent wearable device, a monitoring data processing device, or a radar data processing device. This is not limited herein. The execution device 1300 described in the embodiment corresponding to FIG. 13 may be deployed on the execution device 1500, and is configured to implement a function of the execution device 1300 in the embodiment corresponding to FIG. 13. Specifically, the execution device 1500 includes a receiver 1501, a transmitter 1502, a processor 1503, and a memory 1504 (there may be one or more processors 1503 in the execution device 1500, and one processor is used as an example in FIG. 15). The processor 1503 may include an application processor 15031 and a communication processor 15032. In some embodiments of this application, the receiver 1501, the transmitter 1502, the processor 1503, and the memory 1504 may be connected through a bus or in another manner.

The memory 1504 may include a read-only memory and a random access memory, and provide instructions and data for the processor 1503. A part of the memory 1504 may further include a non-volatile random access memory (NVRAM). The memory 1504 stores a processor and operation instructions, an executable module or a data structure, a subnet thereof, or an extended set thereof. The operation instructions may include various operation instructions to implement various operations.

The processor 1503 controls an operation of the execution device 1500. In a specific application, the components of the execution device 1500 are coupled together through a bus system. In addition to a data bus, the bus system may further include a power bus, a control bus, a status signal bus, and the like. However, for clear description, various types of buses in the figure are marked as the bus system.

The method disclosed in the embodiment corresponding to FIG. 8 in this application may be applied to the processor 1503, or may be implemented by the processor 1503. The processor 1503 may be an integrated circuit chip, and has a signal processing capability. In an implementation process, operations in the foregoing methods may be implemented by using a hardware integrated logical circuit in the processor 1503, or by using instructions in a form of software. The processor 1503 may be a general-purpose processor, a digital signal processor (DSP), a microprocessor, or a microcontroller; or may further include an application-specific integrated circuit (ASIC), a field-programmable gate array (FPGA) or another programmable logic device, a discrete gate or transistor logic device, or a discrete hardware component. The processor 1503 may implement or perform the methods, operations, and logic block diagrams disclosed in the embodiment corresponding to FIG. 8 in this application. The general-purpose processor may be a microprocessor, or the processor may be any conventional processor or the like. Operations of the methods disclosed with reference to embodiments of this application may be directly performed by a hardware decoding processor, or may be performed by using a combination of hardware and software modules in the decoding processor. The software module may be located in a mature storage medium in the art, for example, a random access memory, a flash memory, a read-only memory, a programmable read-only memory, an electrically erasable programmable memory, a register, or the like. The storage medium is located in the memory 1504, and the processor 1503 reads information in the memory 1504 and completes the operations in the foregoing methods in combination with hardware in the processor 1503.

The receiver 1501 may be configured to: receive input digital or character information, and generate a signal input related to a related setting and function control of the execution device 1500. The transmitter 1502 may be configured to output digital or character information through a first interface. The transmitter 1502 may be further configured to send instructions to a disk group through the first interface to modify data in the disk group. The transmitter 1502 may further include a display device such as a display.

In this embodiment of this application, in a case, the processor 1503 is configured to perform corresponding data processing on input data by using a trained target convolutional neural network to obtain corresponding output data (that is, a prediction result). The trained target convolutional neural network may be obtained by using the training method corresponding to FIG. 3 or FIG. 6 in this application. For specific content, refer to the description in the foregoing method embodiments in this application. Details are not described herein again.

An embodiment of this application further provides a computer-readable storage medium. The computer-readable storage medium stores a program for signal processing. When the program runs on a computer, the computer is enabled to perform the operations performed by the training device described in the foregoing embodiment, or the computer is enabled to perform the operations performed by the execution device described in the embodiment shown in FIG. 3, FIG. 6, or FIG. 8.

The training device or the execution device in embodiments of this application may specifically be a chip. The chip includes a processing unit and a communication unit. The processing unit may be, for example, a processor, and the communication unit may be, for example, an input/output interface, a pin, or a circuit. The processing unit may execute computer-executable instructions stored in a storage unit, to enable the chip in the training device to perform the operations performed by the training device described in the foregoing embodiment, or to enable the chip in the execution device to perform the operations performed by the execution device described in the embodiment shown in FIG. 3, FIG. 6, or FIG. 8.

Optionally, the storage unit is a storage unit in the chip, for example, a register or a cache; or the storage unit may be a storage unit that is in a radio access device and that is located outside the chip, for example, a read-only memory (ROM), another type of static storage device that can store static information and instructions, or a random access memory (RAM).

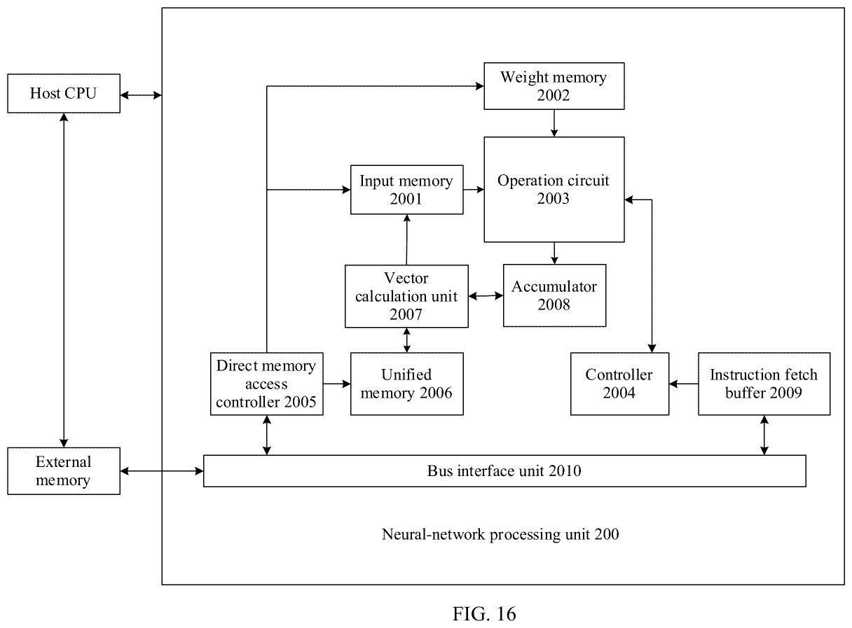

Specifically, FIG. 16 is a schematic diagram of a structure of a chip according to an embodiment of this application. The chip may be represented as a neural-network processing unit NPU 200. The NPU 200 is mounted to a host CPU as a coprocessor, and the host CPU allocates a task. A core part of the NPU is an operation circuit 2003, and a controller 2004 controls the operation circuit 2003 to extract matrix data in a memory and perform a multiplication operation.

In some implementations, the operation circuit 2003 includes a plurality of processing engines (PE) inside. In some implementations, the operation circuit 2003 is a two-dimensional systolic array. The operation circuit 2003 may alternatively be a one-dimensional systolic array or another electronic circuit that can perform mathematical operations such as multiplication and addition. In some implementations, the operation circuit 2003 is a general-purpose matrix processor.

For example, it is assumed that there is an input matrix A, a weight matrix B, and an output matrix C. The operation circuit fetches data corresponding to the matrix B from a weight memory 2002, and buffers the data on each PE in the operation circuit. The operation circuit fetches data of the matrix A from an input memory 2001, to perform a matrix operation on the matrix B, and stores an obtained partial result or an obtained final result of the matrix into an accumulator 2008.

A unified memory 2006 is configured to store input data and output data. Weight data is directly transferred to the weight memory 2002 by using a direct memory access controller (DMAC) 2005. The input data is also transferred to the unified memory 2006 by using the DMAC.

A bus interface unit 2010 (BIU) is configured to interact with the DMAC and an instruction fetch buffer (IFB) 2009 through an AXI bus.

The bus interface unit 2010 is configured for the instruction fetch buffer 2009 to obtain instructions from an external memory, and is further configured for the direct memory access controller 2005 to obtain original data of the input matrix A or the weight matrix B from the external memory.

The DMAC is mainly configured to transfer input data in the external memory DDR to the unified memory 2006, or transfer the weight data to the weight memory 2002, or transfer the input data to the input memory 2001.

A vector calculation unit 2007 includes a plurality of operation processing units. If required, further processing is performed on an output of the operation circuit, for example, vector multiplication, vector addition, an exponential operation, a logarithmic operation, or size comparison. The vector calculation unit 2007 is mainly configured to perform network calculation at a non-convolutional/fully connected layer in a neural network, for example, batch normalization, pixel-level summation, and upsampling on a feature plane.

In some implementations, the vector calculation unit 2007 can store a processed output vector in the unified memory 2006. For example, the vector calculation unit 2007 may apply a linear function or a non-linear function to the output of the operation circuit 2003, for example, perform linear interpolation on a feature plane extracted at a convolutional layer. For another example, the linear function or the non-linear function is applied to a vector of an accumulated value to generate an activation value. In some implementations, the vector calculation unit 2007 generates a normalized value, a pixel-level sum, or a normalized value and a pixel-level sum. In some implementations, the processed output vector can be used as an activation input of the operation circuit 2003, for example, to be used in a subsequent layer in the neural network.

The instruction fetch buffer 2009 connected to the controller 2004 is configured to store instructions used by the controller 2004.

The unified memory 2006, the input memory 2001, the weight memory 2002, and the instruction fetch buffer 2009 are all on-chip memories. The external memory is private for an NPU hardware architecture.

The processor mentioned anywhere above may be a general-purpose central processing unit, a microprocessor, an ASIC, or one or more integrated circuits that are configured to control program execution of the method according to the first aspect.

In addition, it should be noted that the described apparatus embodiments are merely examples. The units described as separate parts may or may not be physically separate, and parts displayed as units may or may not be physical units, and may be located in one position, or may be distributed on a plurality of network units. Some or all the modules may be selected based on an actual requirement to achieve the objectives of the solutions of embodiments. In addition, in the accompanying drawings of the apparatus embodiments provided in this application, connection relationships between the modules indicate that the modules have communication connections with each other, which may be specifically implemented as one or more communication buses or signal cables.

Based on the description of the foregoing implementations, a person skilled in the art may clearly understand that this application may be implemented by software in addition to necessary universal hardware, or certainly may be implemented by dedicated hardware, including an application-specific integrated circuit, a dedicated CPU, a dedicated memory, a dedicated component, and the like. Generally, any function performed by a computer program can be easily implemented by using corresponding hardware, and a specific hardware structure used to achieve a same function may be of various forms, for example, in a form of an analog circuit, a digital circuit, an application-specific circuit, or the like. However, in this application, a software program implementation is a better implementation in most cases. Based on such an understanding, the technical solutions of this application essentially or the part contributing to the conventional technology may be implemented in a form of a software product. The computer software product is stored in a readable storage medium, such as a floppy disk, a USB flash drive, a removable hard disk, a ROM, a RAM, a magnetic disk, or an optical disc of a computer, and includes several instructions for instructing a computer device (which may be a personal computer, a training device, or a network device) to perform the methods described in embodiments of this application.

All or some of foregoing embodiments may be implemented by using software, hardware, firmware, or any combination thereof. When the software is used to implement embodiments, all or a part of embodiments may be implemented in a form of a computer program product.

The computer program product includes one or more computer instructions. When the computer program instructions are loaded and executed on the computer, the procedures or functions according to embodiments of this application are all or partially generated. The computer may be a general-purpose computer, a special-purpose computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, training device, or data center to another website, computer, training device, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a training device or a data center, integrating one or more usable media. The usable medium may be a magnetic medium (for example, a floppy disk, a hard disk, or a magnetic tape), an optical medium (for example, a DVD), a semiconductor medium (for example, a solid state disk (SSD)), or the like.

What is claimed is:

1. A convolutional neural network pruning processing method, comprising:
determining a first sub-loss function based on a target task, wherein the first sub-loss function represents a difference between a training sample input to a target convolutional neural network and an output prediction result, the target convolutional neural network is a convolutional neural network used for training, the target convolutional neural network has different network parameters and loss functions in training processes for different training samples, and the training sample is a sample in a training set;
obtaining a second sub-loss function based on a channel importance function and a dynamic weight, wherein when a value of the first sub-loss function does not reach a first threshold, a value of the dynamic weight is obtained based on the value of the first sub-loss function, and the value of the dynamic weight is in an inverse correlation with the value of the first sub-loss function;
obtaining an objective loss function based on the first sub-loss function and the second sub-loss function; and
performing sparse training on the target convolutional neural network by using the objective loss function to obtain a trained target convolutional neural network, wherein the sparse training is pruning a convolution kernel of the target convolutional neural network based on a value of the channel importance function.

2. The method according to claim 1, wherein the obtaining an objective loss function based on the first sub-loss function and the second sub-loss function comprises:
adding the first sub-loss function and the second sub-loss function to obtain the objective loss function.

3. The method according to claim 1, further comprising:
before the obtaining an objective loss function based on the first sub-loss function and the second sub-loss function, obtaining a third sub-loss function based on a first similarity and a second similarity, wherein the first similarity represents a similarity between a feature map extracted from a first training sample and a feature map extracted from a second training sample, the second similarity represents a similarity between a first channel importance parameter and a second channel importance parameter, the first channel importance parameter is a value that is obtained by inputting the first training sample and that is of the channel importance function, the second channel importance parameter is a value that is obtained by inputting the second training sample and that is of the channel importance function, and the first training sample and the second training sample are two different samples in the training set; and
wherein the obtaining an objective loss function based on the first sub-loss function and the second sub-loss function comprises:
obtaining the objective loss function based on the first sub-loss function, the second sub-loss function, and the third sub-loss function.

4. The method according to claim 3, wherein the obtaining a third sub-loss function based on a first similarity and a second similarity comprises:
using a distance function between the first similarity and the second similarity as the third sub-loss function.

5. The method according to claim 3, wherein
the first similarity represents a cosine similarity between the feature map extracted from the first training sample and the feature map extracted from the second training sample; and
the second similarity represents a cosine similarity between the first channel importance parameter and the second channel importance parameter.

6. The method according to claim 3, wherein the obtaining the objective loss function based on the first sub-loss function, the second sub-loss function, and the third sub-loss function comprises:
adding the first sub-loss function, the second sub-loss function, and a first product result to obtain the objective loss function, wherein the first product result is a result obtained by multiplying the third sub-loss function by a first preset coefficient.

7. The method according to claim 1, wherein that a value of the dynamic weight is obtained based on the value of the first sub-loss function comprises:
obtaining the value of the dynamic weight by multiplying a first ratio by a second preset coefficient, wherein the first ratio is a ratio of a first difference to the first threshold, and the first difference is a difference between the first threshold and the value of the first sub-loss function.

8. The method according to claim 1, wherein the obtaining a second sub-loss function based on a channel importance function and a dynamic weight comprises:
multiplying the channel importance function by the dynamic weight to obtain the second sub-loss function.

9. The method according to claim 1, wherein
when the value of the first sub-loss function reaches the first threshold, the value of the dynamic weight is 0.

10. The method according to claim 1, wherein the determining a first sub-loss function based on a target task comprises:
when the target task is a classification task, determining a cross-entropy loss function as the first sub-loss function.

11. A data processing method, comprising:
obtaining input data related to a target task;
pruning a trained target convolutional neural network based on the input data to obtain a pruned sub-network, wherein the trained target convolutional neural network is obtained through training by using an objective loss function, the objective loss function is obtained based on a first sub-loss function and a second sub-loss function, the first sub-loss function is determined based on the target task, the second sub-loss function is determined based on a channel importance function and a dynamic weight, the first sub-loss function represents a difference between a training sample input to the target convolutional neural network and an output prediction result, when a value of the first sub-loss function does not reach a first threshold, a value of the dynamic weight is obtained based on the value of the first sub-loss function, the value of the dynamic weight is in an inverse correlation with the value of the first sub-loss function, the objective loss function is used to perform sparsening on the target convolutional neural network during training of the target convolutional neural network, and the sparsening is pruning a convolution kernel of the target convolutional neural network based on a value of the channel importance function; and
processing the input data by using the sub-network to obtain output data.

12. The method according to claim 11, wherein the pruning a trained target convolutional neural network based on the input data to obtain a pruned sub-network comprises:
pruning the trained target convolutional neural network based on the input data and a pruning rate to obtain the pruned sub-network, wherein the pruning rate is a proportion of the pruned convolution kernel to all convolution kernels in the target convolutional neural network.

13. The method according to claim 11, wherein that a value of the dynamic weight is obtained based on the value of the first sub-loss function comprises:
obtaining the value of the dynamic weight by multiplying a first ratio by a second preset coefficient, wherein the first ratio is a ratio of a first difference to the first threshold, and the first difference is a difference between the first threshold and the value of the first sub-loss function.

14. The method according to claim 11, wherein when the value of the first sub-loss function reaches the first threshold, the value of the dynamic weight is 0.

15. The method according to claim 11, wherein the input data comprises:
image data, audio data, and text data.

16. A training device, comprising:
a first determining module, configured to determine a first sub-loss function based on a target task, wherein the first sub-loss function represents a difference between a training sample input to a target convolutional neural network and an output prediction result, the target convolutional neural network is a convolutional neural network used for training, the target convolutional neural network has different network parameters and loss functions in training processes for different training samples, and the training sample is a sample in a training set;
a second determining module, configured to obtain a second sub-loss function based on a channel importance function and a dynamic weight, wherein when a value of the first sub-loss function does not reach a first threshold, a value of the dynamic weight is obtained based on the value of the first sub-loss function, and the value of the dynamic weight is in an inverse correlation with the value of the first sub-loss function;
a third determining module, configured to obtain an objective loss function based on the first sub-loss function and the second sub-loss function; and
a training module, configured to perform sparse training on the target convolutional neural network by using the objective loss function to obtain a trained target convolutional neural network, wherein the sparse training is pruning a convolution kernel of the target convolutional neural network based on a value of the channel importance function.

17. The training device according to claim 16, wherein the third determining module is configured to:
add the first sub-loss function and the second sub-loss function to obtain the objective loss function.

18. The training device according to claim 16, wherein the second determining module is further configured to:
obtain a third sub-loss function based on a first similarity and a second similarity, wherein the first similarity represents a similarity between a feature map extracted from a first training sample and a feature map extracted from a second training sample, the second similarity represents a similarity between a first channel importance parameter and a second channel importance parameter, the first channel importance parameter is a value that is obtained by inputting the first training sample and that is of the channel importance function, the second channel importance parameter is a value that is obtained by inputting the second training sample and that is of the channel importance function, and the first training sample and the second training sample are any two different samples in the training set; and
the third determining module is further configured to:
obtain the objective loss function based on the first sub-loss function, the second sub-loss function, and the third sub-loss function.

19. The training device according to claim 18, wherein the second determining module is further configured to:
use a distance function between the first similarity and the second similarity as the third sub-loss function.

20. The training device according to claim 18, wherein
the first similarity represents a cosine similarity between the feature map extracted from the first training sample and the feature map extracted from the second training sample; and
the second similarity represents a cosine similarity between the first channel importance parameter and the second channel importance parameter.
